(19) United States
(12) Patent Application Publication
(10) Pub. No.: US 2025/0284576 A1
(43) Pub. Date: Sep. 11, 2025

(54) INTER-PEER APPARATUS COMMUNICATIONS USING A CENTRAL NETWORK ENTITY

(71) Applicant: QUALCOMM Incorporated, San Diego, CA (US)

(72) Inventors: Karl Georg HAMPEL, Jersey City, NJ (US); Shankar KRISHNAN, San Diego, CA (US); Naeem AKL, Bridgewater, NJ (US); Prasad Reddy KADIRI, San Diego, CA (US)

(21) Appl. No.: 18/598,545

(22) Filed: Mar. 7, 2024

(51) Int. Cl. G06F 9/54; H04W 24/02

(52) U.S. Cl. CPC G06F 9/547; H04W 24/02

(57) ABSTRACT

Certain aspects of the present disclosure provide techniques for techniques for inter-evolved distributed unit (eDU) communications. A method generally includes communicating, by an apparatus with a network entity via a first type of application programming interface (API) at the network entity, to register the apparatus with the network entity; and exchanging metric(s) with peer apparatus(es) associated with the network entity based on: a first communication with the peer apparatus(es) via a second type of API and/or a third type of API exposed at the apparatus; a second communication with the one or more peer apparatuses via the second type of API and/or the third type of API at each of the peer apparatus(es); a third communication with the network entity via the second type of API at the network entity; and/or a fourth communication with the network entity via the third type of API exposed at the apparatus.

### FIELD OF THE DISCLOSURE

Aspects of the present disclosure relate to wireless communications, and more particularly, to techniques for inter-peer apparatus (e.g., peer network entity, such as a distributed unit (DU), such as an evolved distributed unit (eDU)) communications in wireless communications networks.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes communicating, with a network entity, via a first type of application programming interface (API) at the network entity, to register the apparatus with the network entity; and exchanging one or more metrics with one or more peer apparatuses associated with the network entity based on at least one of: a first communication with the one or more peer apparatuses via at least one of a second type of API or a third type of API exposed at the apparatus; a second communication with the one or more peer apparatuses via at least one of the second type of API or the third type of API at each of the one or more peer apparatuses; a third communication with the network entity via the second type of API at the network entity; or a fourth communication with the network entity via the third type of API exposed at the apparatus.

Another aspect provides one or more apparatuses configured for wireless communications. The one or more apparatuses include one or more memories and one or more processors, coupled to the one or more memories, configured to cause the one or more apparatuses to communicate, with a network entity, via a first type of API at the network entity, to register the one or more apparatuses with the network entity; and exchange one or more metrics with one or more peer apparatuses associated with the network entity based on at least one of: a first communication with the one or more peer apparatuses via at least one of a second type of API or a third type of API exposed at the one or more apparatuses; a second communication with the one or more peer apparatuses via at least one of the second type of API or the third type of API at each of the one or more peer apparatuses; a third communication with the network entity via the second type of API at the network entity; or a fourth communication with the network entity via the third type of API exposed at the one or more apparatuses. For example, performance of any of the above steps may be by only one apparatus or by multiple apparatuses in a distributed fashion.

Another aspect provides one or more apparatuses configured for wireless communications. The one or more apparatuses include means for communicating, with a network entity, via a first type of API at the network entity, to register the one or more apparatuses with the network entity; and means for exchanging one or more metrics with one or more peer apparatuses associated with the network entity based on at least one of: a first communication with the one or more peer apparatuses via at least one of a second type of API or a third type of API exposed at the one or more apparatuses; a second communication with the one or more peer apparatuses via at least one of the second type of API or the third type of API at each of the one or more peer apparatuses; a third communication with the network entity via the second type of API at the network entity; or a fourth communication with the network entity via the third type of API exposed at the one or more apparatuses. For example, performance of any of the above steps may be by only one apparatus or by multiple apparatuses in a distributed fashion.

Another aspect provides one or more non-transitory computer-readable media. The one or more non-transitory computer-readable media include executable instructions that, when executed by one or more processors of one or more apparatuses, cause the one or more apparatuses to communicate, with a network entity, via a first type of API at the network entity, to register the one or more apparatuses with the network entity; and exchange one or more metrics with one or more peer apparatuses associated with the network entity based on at least one of: a first communication with the one or more peer apparatuses via at least one of a second type of API or a third type of API exposed at the one or more apparatuses; a second communication with the one or more peer apparatuses via at least one of the second type of API or the third type of API at each of the one or more peer apparatuses; a third communication with the network entity via the second type of API at the network entity; or a fourth communication with the network entity via the third type of API exposed at the one or more apparatuses. For example, the instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses.

Some examples of the methods, apparatuses, and non-transitory computer-readable media described herein may further include operations, features, means, or instructions for sending, to the network entity, via the second type of API at the network entity or a fourth type of API, a request to communicate the one or more metrics directly with the one or more peer apparatuses; and receiving a message comprising location information for each of the one or more peer apparatuses.

In some examples of the methods, apparatuses, and non-transitory computer-readable media described herein, the location information for each of the one or more peer apparatuses comprises a fully qualified domain name (FQDN) or an internet protocol (IP) address.

Some examples of the methods, apparatuses, and non-transitory computer-readable media described herein may further include operations, features, means, or instructions for sending, to the network entity, via the second type of API at the network entity or a fourth type of API, a message comprising location information for each of the one or more peer apparatuses.

Some examples of the methods, apparatuses, and non-transitory computer-readable media described herein may further include operations, features, means, or instructions for receiving, from the network entity, via the third type of API at the one or more apparatuses or a fourth type of API, a message comprising location information for each of the one or more peer apparatuses.

In some examples of the methods, apparatuses, and non-transitory computer-readable media described herein, exchanging the one or more metrics based on the first communication with the one or more peer apparatuses via at least one of the second type of API or the third type of API exposed at the one or more apparatuses comprises: receiving, directly from a first peer apparatus of the one or more peer apparatuses, via the second type of API or the third type of API, a request for at least one metric of the one or more metrics; and sending, directly to the first peer apparatus, the at least one metric in a return message to the request.

In some examples of the methods, apparatuses, and non-transitory computer-readable media described herein, the at least one metric comprises: information associated with the one or more apparatuses; or information associated with at least one peer apparatus associated with the first peer apparatus.

In some examples of the methods, apparatuses, and non-transitory computer-readable media described herein, exchanging the one or more metrics based on the first communication with the one or more peer apparatuses via at least one of the second type of API or the third type of API exposed at the one or more apparatuses comprises receiving, directly from a first peer apparatus of the one or more peer apparatuses, via the second type of API or the third type of API, at least one metric of the one or more metrics.

In some examples of the methods, apparatuses, and non-transitory computer-readable media described herein, exchanging the one or more metrics based on the second communication with the one or more peer apparatuses via at least one of the second type of API or the third type of API at each of the one or more peer apparatuses comprises: sending, directly to a first peer apparatus of the one or more peer apparatuses, via the second type of API or the third type of API at the first peer apparatus, a request for at least one metric of the one or more metrics; and receiving, directly from the first peer apparatus, the at least one metric in a return message to the request.

In some examples of the methods, apparatuses, and non-transitory computer-readable media described herein, exchanging the one or more metrics based on the second communication with the one or more peer apparatuses via at least one of the second type of API or the third type of API at each of the one or more peer apparatuses comprises sending, directly to a first peer apparatus of the one or more peer apparatuses, via the second type of API or the third type of API at the first peer apparatus, at least one metric of the one or more metrics.

In some examples of the methods, apparatuses, and non-transitory computer-readable media described herein, the one or more metrics comprise information associated with the one or more apparatuses. In some examples of the methods, apparatuses, and non-transitory computer-readable media described herein, exchanging the one or more metrics based on the third communication with the network entity via the second type of API at the network entity comprise sending, to the network entity, via the second type of API, the one or more metrics.

In some examples of the methods, apparatuses, and non-transitory computer-readable media described herein, the one or more metrics comprise information associated with at least one of the one or more peer apparatuses associated with the one or more apparatuses. In some examples of the methods, apparatuses, and non-transitory computer-readable media described herein, exchanging the one or more metrics based on the third communication with the network entity via the second type of API at the network entity comprises: sending, to the network entity, via the second type of API, a request for the one or more metrics; and receiving, from the network entity, the one or more metrics in a return message to the request.

In some examples of the methods, apparatuses, and non-transitory computer-readable media described herein, the one or more metrics comprise information associated with the one or more apparatuses. In some examples of the methods, apparatuses, and non-transitory computer-readable media described herein, exchanging the one or more metrics based on the fourth communication with the network entity via the third type of API exposed at the one or more apparatuses comprises: receiving, from the network entity, via the third type of API, a request for the one or more metrics; and sending, to the network entity the one or more metrics in a return message to the request.

In some examples of the methods, apparatuses, and non-transitory computer-readable media described herein, the one or more metrics comprise information associated with at least one of the one or more peer apparatuses associated with the one or more apparatuses. In some examples of the methods, apparatuses, and non-transitory computer-readable media described herein, exchanging the one or more metrics based on the fourth communication with the network entity via the third type of API exposed at the one or more apparatuses comprises receiving, from the network entity, via the third type of API, the one or more metrics.

In some examples of the methods, apparatuses, and non-transitory computer-readable media described herein, communicating, with the network entity, to register the one or more apparatuses with the network entity, comprises providing the network entity with an identifier associated with the one or more apparatuses comprising at least one of: a fully qualified domain name (FQDN); an internet protocol (IP) address; a geolocation; an identification (ID) number; or a cell ID.

Some examples of the methods, apparatuses, and non-transitory computer-readable media described herein may further include operations, features, means, or instructions for receiving a token based on a successful registration of the one or more apparatuses with the network entity. In some examples of the methods, apparatuses, and non-transitory computer-readable media described herein, exchanging the one or more metrics based on the third communication with the network entity via the second type of API at the network entity comprises sending, to the network entity, via the second type of API, a message comprising the one or more metrics or a request for the one or more metrics. In some examples of the methods, apparatuses, and non-transitory computer-readable media described herein, the message or the request comprises the token.

In some examples of the methods, apparatuses, and non-transitory computer-readable media described herein, the one or more peer apparatuses comprise peer apparatuses associated with the network entity that are neighbors of the one or more apparatuses based on a location of each of the one or more peer apparatuses.

In some examples of the methods, apparatuses, and non-transitory computer-readable media described herein, the one or more metrics comprise at least one of: a cell resource; an air-interface resource; a cell load; a peer apparatus load; an amplifier load; a measurement on a physical channel; a signal strength value; an interference value; a configuration; a timing advance value; a timestamp; a paging indication; or user equipment (UE)-specific information.

An apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIGS. 5A and 5B depict example usage of application programming interfaces (APIs) to exchange information between evolved distributed units (eDUs).

FIGS. 6A-6D depict process flows for communications in a network between a first eDU, a second eDU, and a core network (CN) network function (NF), deployed as a service, to enable inter-eDU communications using relaying techniques.

FIGS. 7A-7C depict process flows for communications in a network between a first eDU, a second eDU, and a CN NF, deployed as a service, to enable direct inter-eDU communications.

FIG. 8 depicts a method for wireless communications.

FIG. 9 depicts aspects of an example communications device.

### DETAILED DESCRIPTION

Aspects of the present disclosure provide apparatuses, methods, processing systems, and computer-readable mediums for enabling inter-peer apparatus communications.

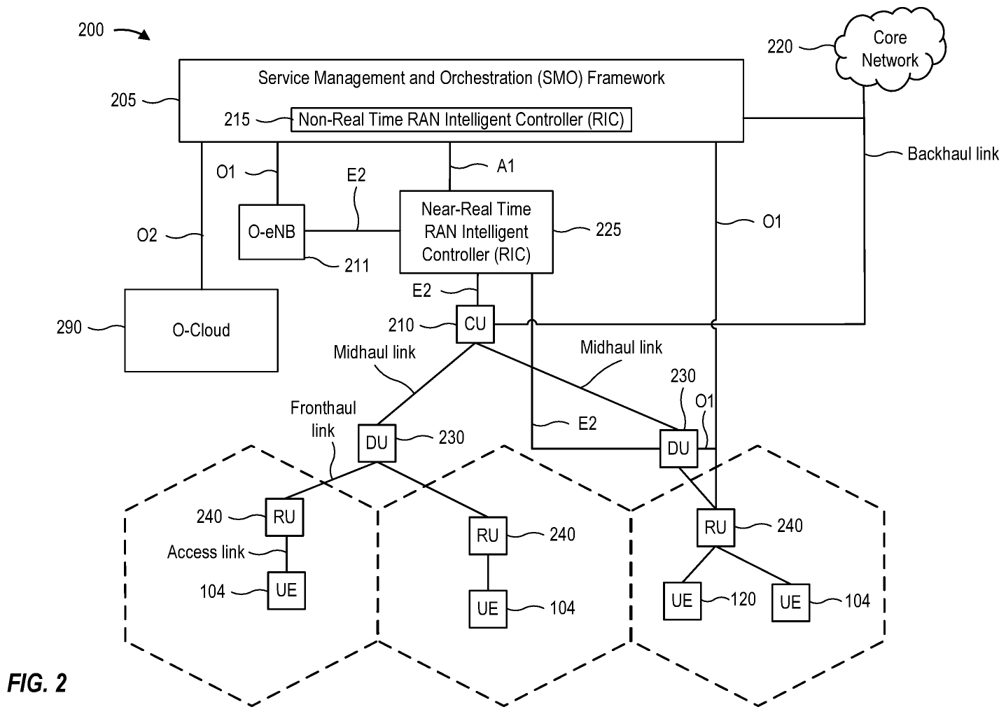

In certain aspects, a peer apparatus is a network entity, such as a distributed unit (DU), which forms part of a base station (BS), such as described with respect to FIG. 2. In certain aspects, the peer apparatus is an evolved DU (eDU), such as a DU configured for wireless communications according to upcoming sixth generation (6G) standards. In certain aspects, a peer apparatus is configured to support a radio access network (RAN) of a wireless communications network.

In certain aspects, peer apparatuses are configured to communicate with another network entity, such as a network entity configured to provide a service/network function, such as extended reality (XR), mobile hologram, digital twin, security, or the like. An example of such a network entity includes a network entity running a core network (CN) network function (NF), which may be deployed as a software-defined service in a cloud environment. It should be noted that when reference is made herein to communication with a CN NF, such communication may accordingly reference communication with the network entity running the CN NF. In certain aspects, the peer apparatuses may be configured to communicate with a network entity configured to provide a service via an interface, such as a service based interface (SBI).

Though certain aspects are discussed herein with respect to eDUs as example peer apparatuses, CN NFs (e.g., deployed as services, such as 6G services) as example network entities configured to provide services, and SBIs as interfaces for ease of illustration, it should be noted that the techniques herein may be similarly used with other peer apparatuses, network entities, and interfaces. Further, though certain aspects are described with respect to 6G standards, the techniques may be applied to other wireless communications standards.

As an example, an SBI may be implemented between an eDU and CN NF(s), deployed as service(s), thereby allowing the CN NF(s) and the eDU to directly consume services from each other. The SBI may be designed as a communication bus that enables the exchange of information between the CN NF(s) and the eDU without the need for an access and mobility management function (AMF) (e.g., a control plane NF of the CN) relaying between the CN NF(s) and the eDU. Exposing CN NF(s) deployed as services through the SBI, instead of using point-to-point protocols, helps to create a more flexible (e.g., by providing deployment autonomy) and extensible architecture for wireless communications networks.

6G wireless networks are example networks designed to implement such architecture between eDU(s) and CN NF(s), deployed as standalone 6G service(s) in cloud infrastructure. Each eDU of the RAN may interact with one or more of the 6G services using an SBI. In particular, each 6G service may expose one or more application programming interfaces (APIs) that are used by the eDUs to communicate with the respective 6G service. Each eDU may activate client(s) (e.g., software) to use the API(s) exposed by the 6G services. For example, a client activated for an eDU may make calls to an API exposed at a 6G service to exchange information with the 6G service (e.g., send information to the 6G service and/or request information from the 6G service). As such, the SBI may enable the exchange of information between an eDU and a 6G service for each eDU and 6G service in 6G wireless networks.

A technical problem associated with this hierarchical communications architecture, however, includes an inherent inability to support inter-eDU communications (e.g., communications between a first eDU and a second eDU). Inter-eDU communications may facilitate the transfer of data and signaling information between eDUs, which may be beneficial for various applications. For example, inter-eDU communications may help support (1) seamless mobility and handover procedures in 6G wireless networks (e.g., where handover is a process of transferring an ongoing communication session of a user equipment (UE) from a source eDU to a target eDU), (2) load balancing between eDUs, (3) eDU coordination, for example with respect to timing advance (TA) determinations (e.g., process of adjusting the timing of signals to help achieve accurate transmission and reception of data), and/or (4) network optimization, to name a few.

In some wireless networks, an interface is introduced that enables communications between two adjacent RAN nodes. For example, in fifth generation (5G) wireless networks, an Xn interface is implemented to allow for inter-next generation (NG) node RAN node communications, or more specifically, inter-NG NodeB (inter-gNB) communications. From a logical standpoint, the Xn interface is a point-to-point interface between two gNBs. The Xn interface supports the exchange of signaling information, as well as the forwarding of protocol data units (PDUs), between two gNBs. In certain aspects, the Xn interface may support procedures for intra-gNB mobility and/or dual connectivity between gNBs (e.g., dual connectivity enables a UE to consume radio resources of two network entities).

While implementing a similar horizontal interface between eDUs in 6G wireless networks may provide a solution that enables inter-eDU communications, this solution may not be desired and/or feasible in some cases. For example, creating a standardized horizontal interface between each pair of eDUS in the RAN may introduce significant implementation overhead, especially where a large number of eDUs exist in the RAN. Further, eDUs in the RAN may be associated with different vendors, which, in some cases, may not allow the use of such horizontal interfaces between eDUs associated with different vendors.

Accordingly, certain aspects herein provide alternative techniques that allow for inter-eDU communications. For example, certain aspects described herein enable communications between eDUs in a RAN using the SBI implemented between the eDUs and the CN NF(s) (also referred to as NF service(s)), for example, deployed as 6G service(s) in 6G wireless networks. Though certain examples are discussed herein with respect to 6G wireless networks and CN NFs deployed as 6G services, the techniques are similarly applicable to other generations of wireless technologies, such as wireless technologies that allow for services to be implemented as a set of cloud native, software-defined services, which are reachable over an interface, such as an SBI.

In certain aspects, the 6G service(s) act as relay(s) to assist the exchange of information between eDUs. For example, a 6G service may obtain information from a first eDU about the first eDU and/or one or more other eDUs, and send this information to a second eDU. The second eDU may operate based on the information received from the 6G service. In certain aspects, the 6G service obtains the information from the first eDU by requesting the information from the first eDU and/or based on the first eDU providing this information to the 6G service (e.g., without solicitation by the 6G service). In certain aspects, the 6G service sends the information to the second eDU based on the second eDU registering with the 6G service, or in other words, requesting call-backs from the 6G service to receive information about other eDUs. As such, inter-eDU communications may be between at least a first eDU, a 6G service, and a second eDU using the SBI implemented between the 6G service and each of the eDUs.

In certain aspects, the SBI implemented between eDUs and 6G service(s) is additionally, or alternatively, leveraged to facilitate direct inter-eDU communications. For example, eDUs may directly exchange information with one another without 6G service relaying. Specifically, a first eDU may directly communicate information associated with the first eDU and/or one or more other eDUs to a second eDU. Further, the second eDU may directly communicate information associated with the second eDU and/or one or more other eDUs to the first eDU.

To facilitate such direct communications between the first eDU and the second eDU, in certain aspects, a 6G service, with an SBI between the first eDU and the second eDU, may (1) provide the first eDU with a list of peer eDU(s), which includes second eDU, (2) and/or provide the second eDU with a list of peer eDU(s), which includes the first eDU. The eDU(s) included in the list of peer eDU(s) provided to the first eDU and/or the second eDU may be used as proxy(ies) of the 6G service. As such, the first eDU and/or the second eDU may communicate with eDU(s) in their respective list of peer eDU(s), as if they were communicating with the 6G service, thereby allowing for direct inter-eDU communications.

In certain aspects, to facilitate direct communications between the first eDU and the second eDU, a 6G service may provide the first eDU with a call-back location of the second eDU and/or provide the second eDU with a call-back location of the first eDU. As used herein, a call-back location may be a network location and/or a geographic location, such as an address, associated with an eDU that may be used by another eDU and/or a 6G service to communicate with/access the eDU and exchange information (e.g., send and/or request information). Example call-back locations associated with eDUs may include a fully qualified domain name (FQDN), an internet protocol (IP) address, a geolocation, and/or an identification (ID) number of an eDU, among others. This may enable the first eDU to perform call-backs to the second eDU and/or the second eDU to perform call-backs to the first eDU, on behalf of the 6G service.

To allow for such exchange of information between eDUs in the RAN, either directly and/or using 6G service(s) as relay(s), certain aspects herein provide APIs (e.g., three APIs) supported by the eDUs and/or the 6G service(s). In certain aspects, a first API, referred to herein as “API1” enables eDU(s) to register with a 6G service exposing API1 and/or other eDU(s) exposing API1. As described above, an eDU may register with a 6G service and/or another eDU, exposing API1, to solicit information about other eDU(s) from the 6G service and/or the other eDU.

In certain aspects, a second API, referred to herein as “API2,” may be exposed by the 6G service(s) and/or the eDU(s). Exposing API2 at a 6G service may allow an eDU to push information about itself to the 6G service and/or request information associated with other eDU(s) registered with the 6G service. Further, an eDU may expose API2 when the eDU is acting as a “proxy” for the 6G service. For example, an eDU may act as a proxy, representing the 6G service, in order to receive information and/or requests for information from other eDU(s).

In certain aspects, a third API, referred to herein as “API3,” may be exposed by the eDU(s). Exposing API3 at an eDU may allow 6G service(s) and/or other eDU(s) to send information to the eDU and/or request information about other eDU(s) from the eDU.

As used herein, “exposing” API(s), such as API1, API2, and/or API3 at a 6G service and/or at an eDU, may enable other 6G service(s) and/or eDU(s) to access the API-exposing entity via an interface(s). For example, in certain aspects, “explosing” an API may refer to running and/or executing code that allows the API to be accessed, by external entities (e.g, such as 6G service(s) and/or eDU(s)) to enable communication between the external entities and the API-exposing entity. Further, in certain aspects, “exposing” an API may include permitting the API to accept and process external requests from external entities, such as requests for information and/or requests to exchange information with the API-exposing entity. For example, an access level setting, associated with the API, may be set to permit the API to accept and process such requests when “exposing” the API. In certain aspects, exposing an API may also refer to send, e.g., broadcasting, to one or more devices availability of the API.

One or more of the above-described APIs may be exposed at one or more of eDUs and/or one or more other 6G service(s) to enable inter-eDU communications. However, it should be noted that different APIs may be exposed by different eDUs and/or 6G services. Further, different methods for exchanging information between eDUs may be used between different eDUs in the RAN (e.g., a first pair of eDUs may communicate using 6G service relaying while a second pair of eDUs may directly communicate with one another).

Further, it should be noted that a “type of API” as used herein may refer to a given API (e.g., API1, API2, or API3), which may be instantiated at one or more network entities, such as one or more peer apparatuses and/or one or more network entities. For example, a first type of API may refer in some cases to API1. Accordingly, the first type of API may be exposed at multiple entities. Each entity at which the first type of API is exposed may separately execute one or more separate instances of the first type of API. For example, a first network entity may execute one or more instances of the first type of API, while a second network entity may separately execute another one or more instances of the first type of API. Further, a given entity exposing the first type of API may have one or more instances of the first type of API running to service API calls, such as running as one or more threads.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

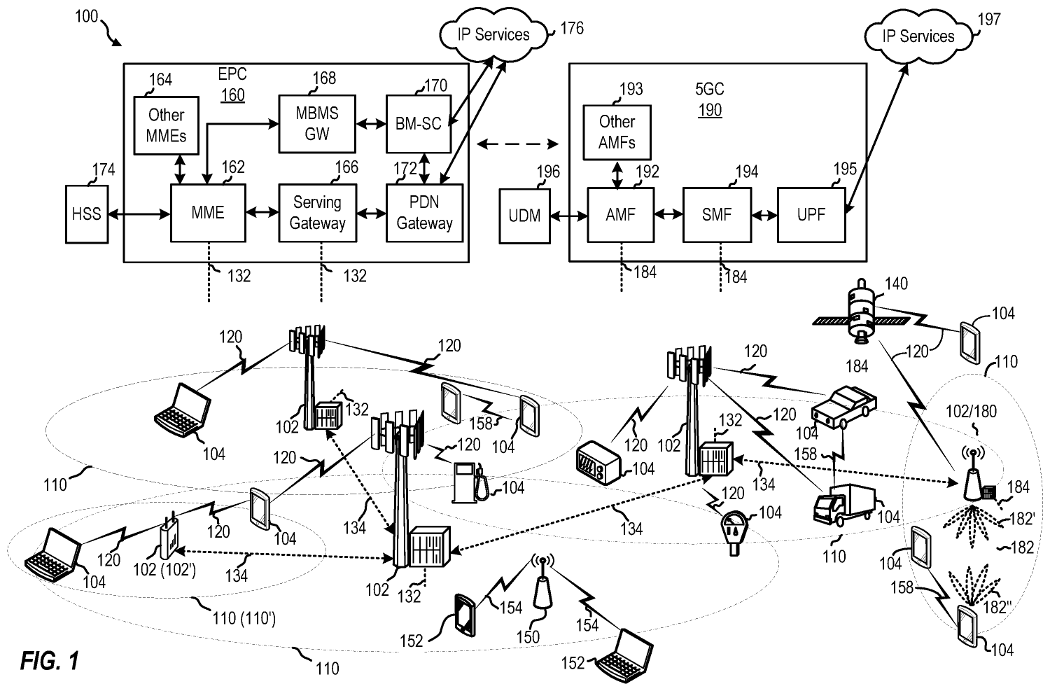

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

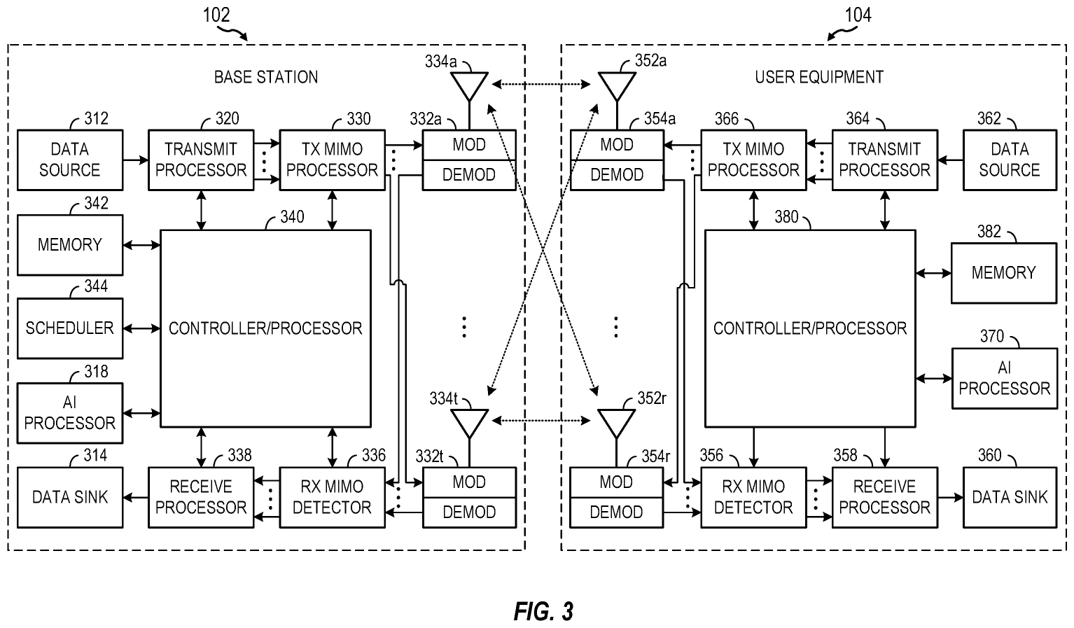

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

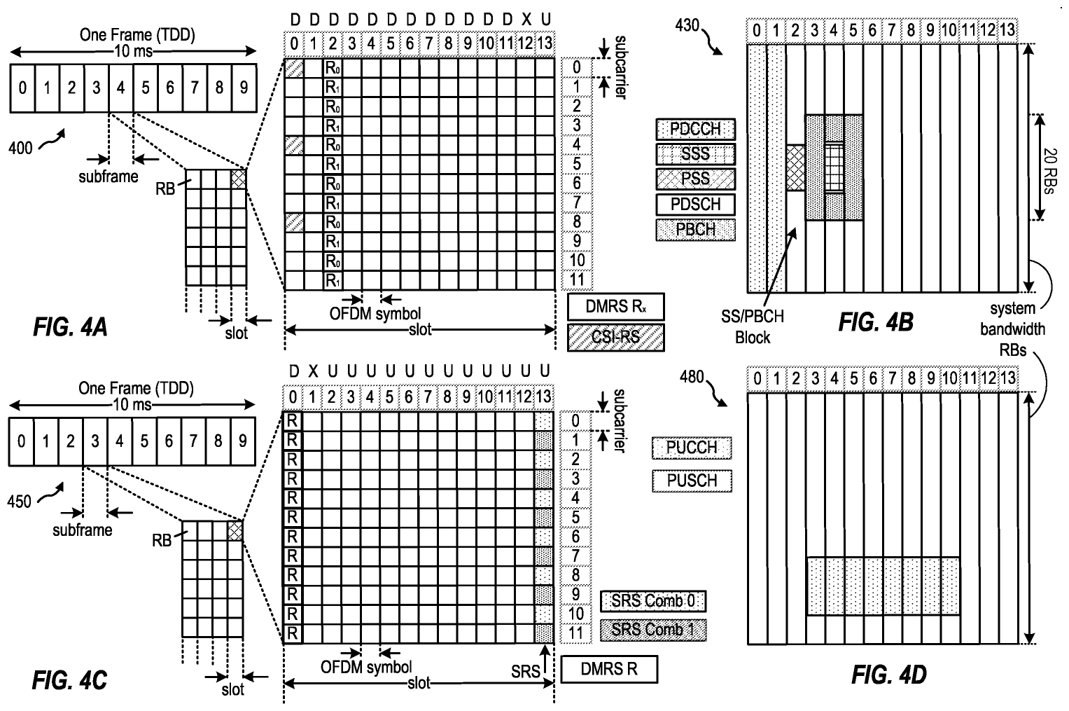

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIG. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Service-Based Architecture (SBA) in 5G and 6G Wireless Communications Networks

As described herein, a wireless communications network (e.g., such as wireless communications network 100 in FIG. 1) includes BSs 102, UEs 104, and one or more CNs. In line with cloudification and virtualization trends, 5G wireless communications networks implement the one or more CNs as a service-based architecture (SBA). In particular, a 5G network includes a 5GC network (e.g., such as 5GC 190 in FIG. 1) deployed with an SBA that allows for 5GC network functions (NFs) (e.g., access and mobility function (AMF), session management function (SMF), policy control function (PCF), etc.) to be implemented as a set of cloud native, software-defined services (referred to herein as “5G services” and individually referred to herein as a “5G service”). Each 5G service is provided by a service producer and can be consumed by one or more service consumers. Further, each 5G service is reachable over a service based interface (SBI). For example, the 5GC SBI is designed as a communication bus that employs a representation state transfer (REST) interface (e.g., a RESTful application programming interface (API) used to exchange information) using hypertext transfer protocol (HTTP/2). Exposing 5G services (e.g., NFs) through the SBI, instead of using point-to-point protocols, as in previous generations of wireless technologies, helps to create a more flexible and extensible architecture for 5G networks.

While the SBA is employed to transform the CN architecture into 5G services that can be independently deployed, operated, and consumed, the SBA does not extend to the RAN of the 5G network. In particular, as described above with respect to FIG. 2, 5G RAN supports split architecture of a BS divided into four network functions: (1) a CU-CP for control plane functionality, (2) a CU-UP for user plane functionality, (3) a DU, and (4) RU(s). To communicate with one or more 5G services (e.g., 5GC NFs), the CU-CP of the RAN connects to an AMF of the 5GC, which acts as a relay to process signaling between the CU-CP and the other 5G service(s). The CU-CP is connected to the AMF via a peer-to-peer interface, as opposed to an SBI. Similarly, signaling from a UE may need to pass through the peer-to-peer connections from DU to CU-CP and then from CU-CP to AMF in order to reach the 5G service(s). The pre-defined anchor points from such peer-to-peer communication often leads to unnecessary transmission overhead and makes deployment of other 5G services dependent on the location of CU-CP and AMF (e.g., which are the anchor points to travel over).

To address such issues, in 6G networks, the SBA is further evolved to include the RAN to allow the RAN to communicate directly with CN NFs (e.g., implemented as 6G services) via an SBI. For example, in 6G wireless networks, the RAN is supported by one or more evolved distributed units (eDUs) (e.g., example 6G BS(s)), while other network functionality is provided by 6G services deployed in cloud infrastructure. The eDU(s) may help to manage local asynchronous connectivity and/or address UE-related issues (e.g., the lower protocol layers of the 6G air interface). The 6G services may centrally manage the eDU(s) of the RAN. For example, the 6G services may address issues related to data network connectivity, mobility, etc.

Each eDU of the RAN may interact with one or more of the 6G services using an SBI. In other words, the RAN-CN interface (e.g., the N2 interface in 5G) evolves into an SBI, thereby enabling the 6G services (e.g., 6G CN NFs) and the RAN to directly consume services from each other without the need for AMF relaying. Each 6G service may expose APIs that are used by the eDUs to communicate with the respective 6G service. For example, each eDU may activate client(s) (e.g., software) to use API(s) exposed by the 6G services. A client activated for an eDU may make requests to an API at a 6G service to exchange information with the API (e.g., send information to the 6G service and/or request information from the 6G service).

While the SBA in 6G offers a more flexible (e.g., deployment autonomy) and agile deployment of innovative services, while also reducing transmission overhead between UEs, eDUs, and 6G services, the SBA is not without limitation. For instance, the above-described architecture is hierarchical in nature and may not allow for inter-eDU communications. Instead, the SBI is used to communicate between a 6G service and an eDU and not between the eDU and another eDU in the RAN. In some cases, enabling inter-eDU communications facilitates the transfer of data and signaling information between eDUs, to thereby (1) help ensure seamless mobility and handover procedures in 6G networks, (2) allow for timing advance (TA) coordination between eDUs for random access channel (RACH)-less access, (3) enable coordination between eDUs for inter-cell interference, (4) allow for dynamic time division duplex (TDD) (e.g., dynamic assignment and reassignment of time domain resources between the uplink and downlink transmission directions) coordination, or the like. Further, in some cases, inter-eDU communications may be critical for time-sensitive scenarios where information needs to be shared between eDUs as soon as it becomes available.

In 5G networks, an Xn interface enables such communication between RAN nodes (e.g., BSs). For example, an Xn interface is defined between each pair of BSs in the RAN to allow for the exchange of control and data information between adjacent BSs. Introducing a similar horizontal interface between eDUs in 6G networks, however, may not be desired. Specifically, a first technical problem associated with implementing a horizontal interface between pairs of eDUs includes the introduction of large implementation overhead in the RAN, especially where the RAN includes a large number of eDUs. Further, 4G and 5G networks have shown that horizontal interfaces are often not exposed across vendors; thus, standardization of a horizontal interface between pairs of eDUs may be useless (e.g., a second technical problem associated with implementing a horizontal interfaces between eDUs). Instead, vendors may use proprietary solutions to avoid inter-vendor operation, thereby circumventing the use of a standardized horizontal interface altogether.

### Aspects Related to Inter-eDU Communications Leveraging an SBI

Aspects described herein overcome the aforementioned technical problems and improve upon the state of the art by introducing techniques that allow for inter-eDU communications without significant implementation overhead. For example, aspects described herein enable communications between eDUs in a RAN using an SBI implemented between the eDUs and NF services, such as 6G services in 6G wireless networks. As described above, though certain examples are discussed with respect to 6G wireless networks and 6G services deployed therein, the techniques discussed herein are applicable to other generations of wireless technologies, such as those that allow for CN NFs to be implemented as a set of cloud native, software-defined services.

In certain aspects, the 6G services act as relays to assist the exchange of information between eDUs. For example, a 6G service may (1) pull (e.g., request and receive) information from a source eDU and/or (2) receive information pushed to the 6G service by a source eDU. As used herein, an information “pull” may refer to the exchange of solicited (e.g., requested) information, while an information “push” may refer to the exchange of unsolicited information. The 6G service may send this information, received from the source eDU, to one or more destination eDUs. The one or more destination eDUs may be eDUs that have registered with the 6G service and solicited the information of other eDU(s), such as the source eDU. As such, inter-eDU communications may be between a source eDU, a 6G service, and one or more destination eDUs using the SBI implemented between the 6G service and each of the eDUs.

In certain aspects, the SBI implemented between eDUs and 6G services is additionally, or alternatively, leveraged to facilitate direct inter-eDU communications. For example, instead of information being exchanged between eDUs using a 6G service as a relay, the eDUs may directly communicate with one another using one or more APIs. In certain aspects, a 6G service may facilitate direct inter-eDU communications between a first eDU and one or more other eDUs by providing the first eDU with a list of the other eDU(s), where the list includes location information (e.g., an FQDN, an IP address, a geolocation, an ID number, etc.) for each of the other eDU(s). The first eDU may treat each eDU in the list of other eDU(s) as a separate instance of the 6G service (e.g., each eDU may be a “proxy” of the 6G service), and thus communicate with the eDU(s) as it would if it were communicating information and/or requesting information from the 6G service. Further, in certain aspects, a 6G service may facilitate direct inter-eDU communications between a first eDU and one or more other eDUs by providing each of the other eDUs with location information for the first eDU. Each of the other eDUs may use this location information for the first eDU to exchange information with the first eDU. For example, the first eDU may register with the 6G service to receive “call-back(s)” from the 6G service about information associated with the other eDU(s), after such information is received by the 6G service. Instead of the 6G service relaying information for each of the other eDU(s) to the first eDU, the 6G service may request that each of the other eDU(s) contact the first eDU directly, to provide the first eDU with information that would have previously been sent to the 6G service (e.g., perform call-backs to the first eDU on behalf of the 6G service).

In certain aspects, the other eDU(s) provided in a list to the first eDU or asked to perform call-backs to the first eDU, are peer eDU(s) (also referred to herein as “neighbor eDUs”) of the first eDU. The 6G service may be responsible for determining peer eDU(s) of the first eDU. The 6G service may make this determination based on one or more criteria. For example, in certain aspects, a peer eDU to the first eDU is an eDU that shares the same frequency band(s) and/or same time-frequency resource(s) as the first eDU (e.g., radio overlap). In certain aspects, a peer eDU to the first eDU is an eDU for which a UE, connected to the first eDU, is dually connected to. In certain aspects, a peer eDU to the first eDU is an eDU that is a candidate target eDU for handing over a UE currently/previously connected to the first eDU. It should be noted that the above-described examples used for identifying peer eDU(s) of a registered eDU are not an exhaustive list, and other criteria for identifying peer eDU(s) may be used.

To allow for such exchange of information between eDUs in the RAN, either directly and/or via 6G service(s) as relay(s), certain aspects herein provide APIs supported by the eDUs and/or the 6G service(s).

In certain aspects, a first API, referred to herein as “API1” enables eDUs to register with a 6G service exposing API1. An eDU may register with the 6G service to be able to receive information about peer eDU(s) from the 6G service. In other words, an eDU may register with the 6G service to receive call-back(s) from the 6G service about information received from peer eDU(s), after such information is received by the 6G service. For example, an eDU may register with a 6G service, exposing API1, to solicit information about peer eDU(s) for which the 6G service has received and/or may receive information about. The 6G service may receive information associated with the peer eDU(s) based on (1) the peer eDU(s) “pushing” information about themselves to the 6G service and/or (2) the 6G service “pulling” this information from the peer eDU(s). The 6G service may relay this received information to the eDU that has registered with the 6G service, thereby enabling the exchange of information between peer eDU(s) and the registered eDU, via use of the 6G service. In certain aspects, API1 may be exposed by one or more of the eDUs to enable other eDU(s) to register with the API1-exposing eDU(s). Registration of an eDU with an API1-exposing eDU may indicate to the API1-exposing eDU that the registering eDU requests to receive information about peer eDU(s) from the API1-exposing eDU (e.g., information about peer eDU(s) received by the API1-exposing eDU).

In certain aspects, a second API, referred to herein as “API2,” may be exposed by the 6G service(s) and/or the eDU(s). Exposing API2 at a 6G service may allow an eDU to push information about itself to the 6G service and/or request information about peer eDU(s) registered with the 6G service. In certain aspects, an eDU may expose API2 when the eDU is acting as a “proxy” for the 6G service. For example, an eDU may act as a proxy, representing the 6G service, in order to receive information and/or requests for information from other eDU(s).

In certain aspects, a third API, referred to herein as “API3,” may be exposed by the eDU(s). Exposing API3 at an eDU may allow 6G service(s) and/or other eDU(s) to push information to the eDU and/or request information about peer eDU(s) from the eDU.

In certain aspects, API2 and API3 represent the same API.

In certain aspects, API1, API2, and/or API3 calls may include information about a specific sub-service offered to an eDU, to a UE in communication with an eDU, or a set of UEs in communication with an eDU. For example, an eDU may offer multiple functions (e.g., sub-services), where API1, API2, and/or API3 refer to a subset of those functions.

In certain aspects, a client at an eDU may be activated to use API1 or API2 exposed at a 6G service to communicate with the 6G service. In certain aspects, when using API1 or API2, the client indicates that it is an eDU and includes an identifier of the eDU and/or an identifier of the 6G service it is communicating with. Similarly, a client at an eDU may be activated to use API1, API2, or API3 exposed at another eDU to communicate with the other eDU. In certain aspects, when using API1, API2, or API3, the client indicates that it is an eDU and includes an identifier of the eDU and/or an identifier of the other eDU it is communicating with. Further, a client at a 6G service may be activated to use API2 or API3 exposed at an eDU to communicate with the eDU. In certain aspects, when using API2 or API3, the client indicates that it is a 6G service and includes an identifier of the 6G service and/or an identifier of the eDU it is communicating with. When sending a return message (e.g., replying) to an API1, API2, and/or API3 call, an eDU and/or a 6G service may also include an identifier of the eDU and/or the 6G service in the return message and/or include an identifier of the eDU and/or the 6G it is communicating with in the return message. The identifiers may help indicate the source and/or destination of the information, which may be useful as there may be several eDUs and/or services communicating different information.

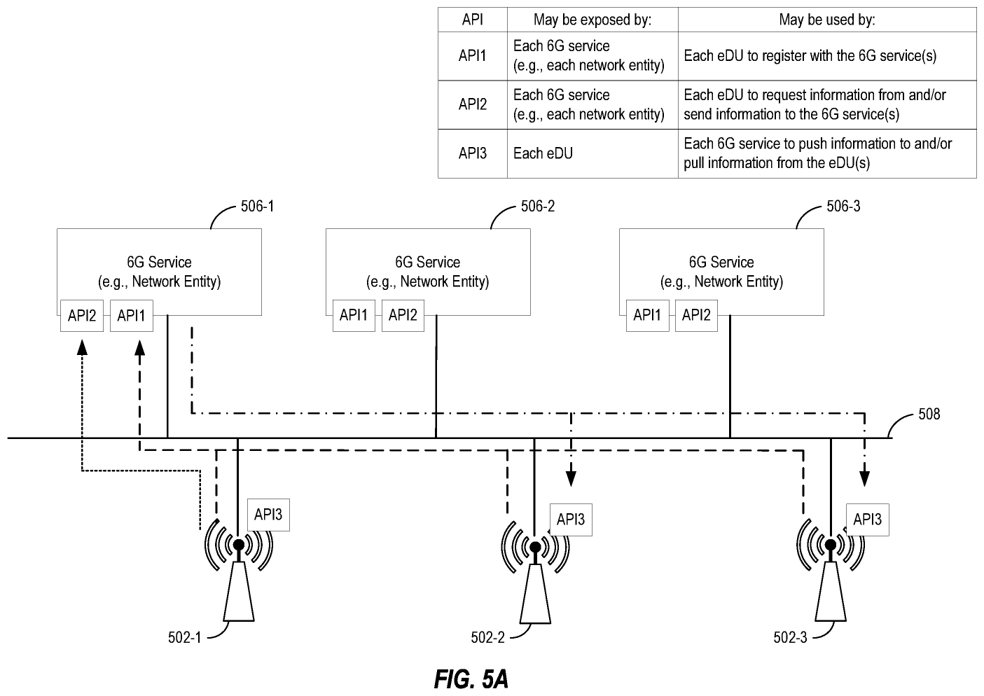

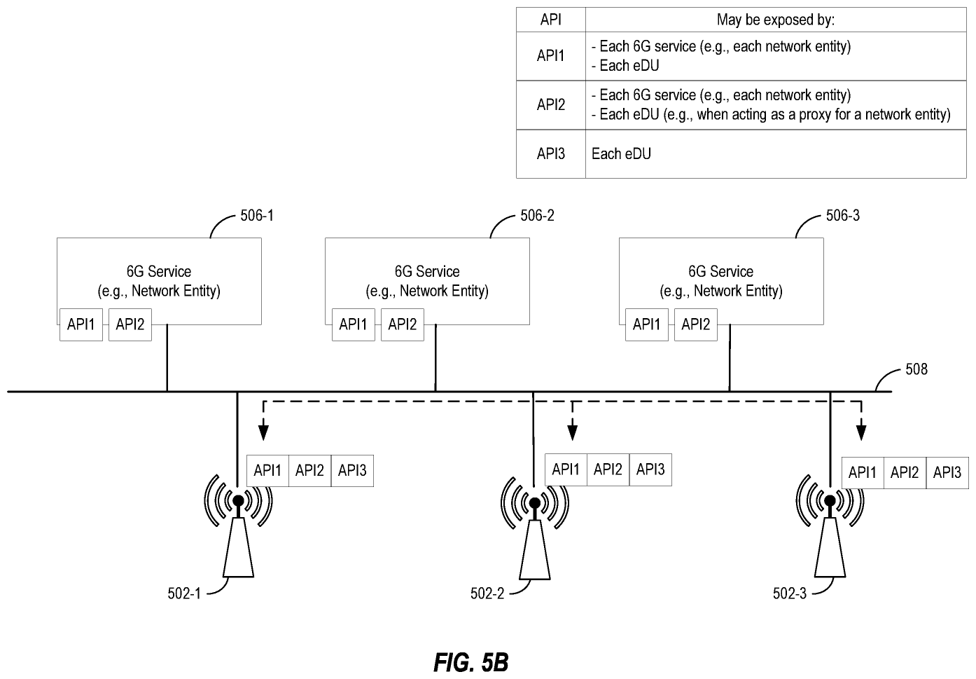

FIGS. 5A and 5B depict example usage of API1, API2, and API3 to exchange information between multiple eDUs. More specifically, FIG. 5A depicts example usage of these APIs to exchange information between the multiple eDUs using the 6G service(s) as relay(s), while FIG. 5B depicts example usage of these APIs to enable direct communication between the multiple eDUs. As shown in FIGS. 5A and 5B, an SBI 508 enables communication between three 6G services 506-1, 506-2, 506-3 (individually referred to herein as “6G service 506” and collectively referred to herein as “6G services 506”) and three eDUs 502-1, 502-2, 502-3 (individually referred to herein as “eDU 502” and collectively referred to herein as “eDUs 502”). Although FIGS. 5A and 5B depict example communication between only three 6G services 506 and three eDUs 502, in other example, more or less 6G services 506 and/or more or less eDUs 502 may be in communication via SBI 508. Each 6G service 506 may be an example of a network entity, such as a CN NF, such as an AMF, an SMF, a PCF, etc. Each eDU 502 may be an example of a network entity, such as BS 102 depicted and described with respect to FIGS. 1 and 3 and/or DU 230 depicted and described with respect to FIG. 2. In this example, eDU 502-2 and eDU 502-3 may be peer eDUs of eDU 502-1, eDU 502-1 and eDU 502-3 may be peer eDUs of eDU 502-2, and eDU 502-1 and eDU 502-2 may be peer eDUs of eDU 502-3.

Though FIGS. 5A and 5B are discussed herein with respect to eDUs as example peer apparatuses, CN NFs (e.g., deployed as services, such as 6G services) as example network entities configured to provide services, and SBIs as interfaces for ease of illustration, it should be noted that the techniques described in FIGS. 5A and 5B may be similarly used with other peer apparatuses, network entities, and interfaces. Further, though FIGS. 5A and 5B are described with respect to a 6G wireless network, the techniques described in FIGS. 5A and 5B may be applied to other generations of wireless networks.

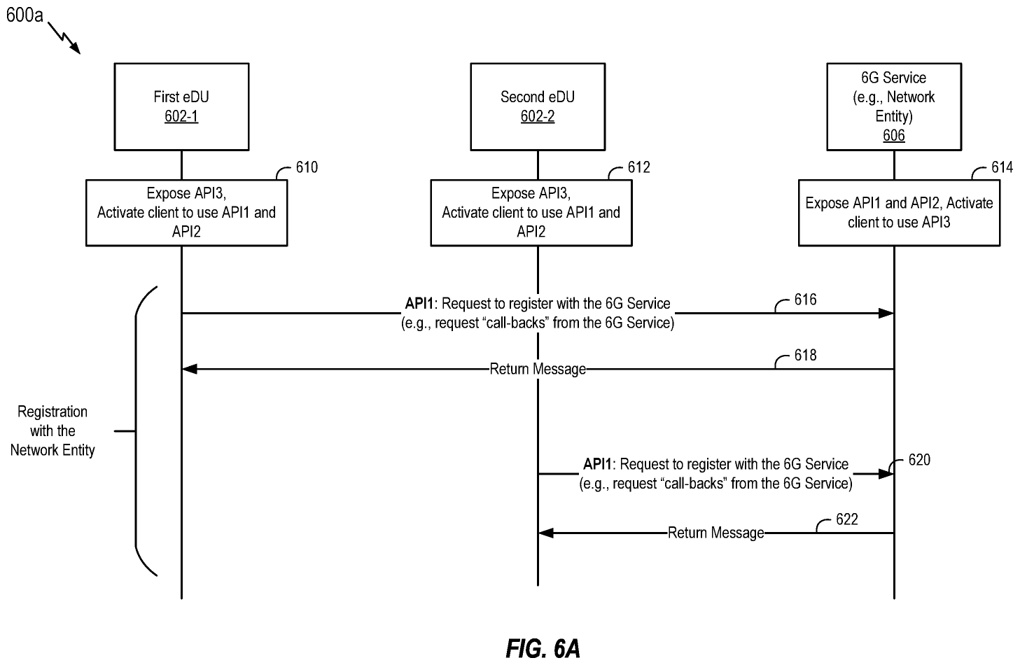

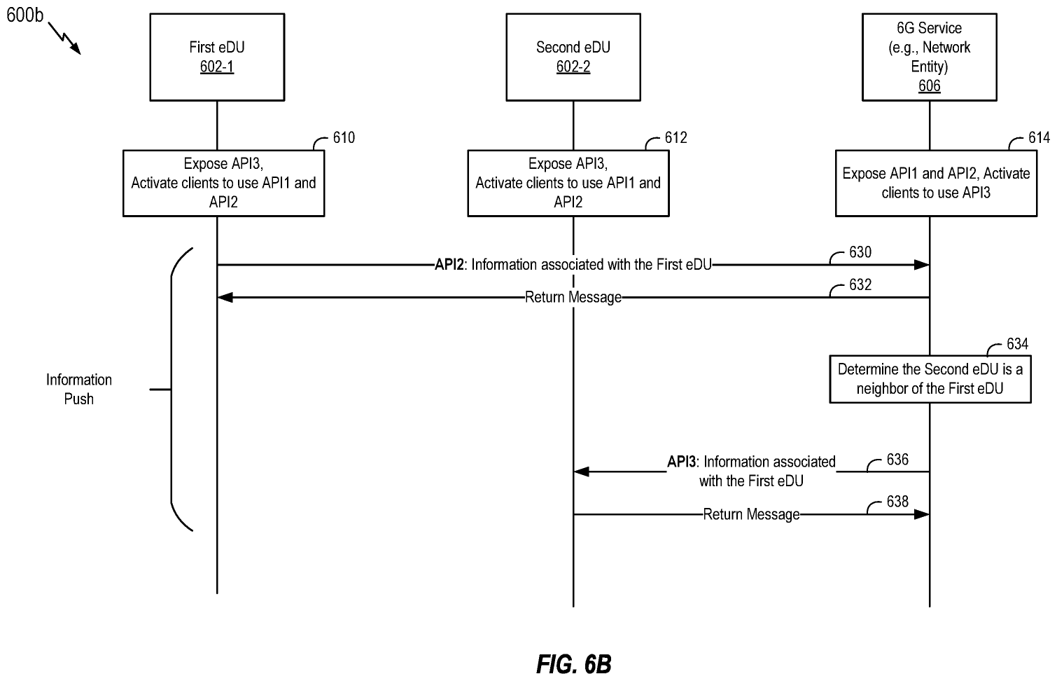

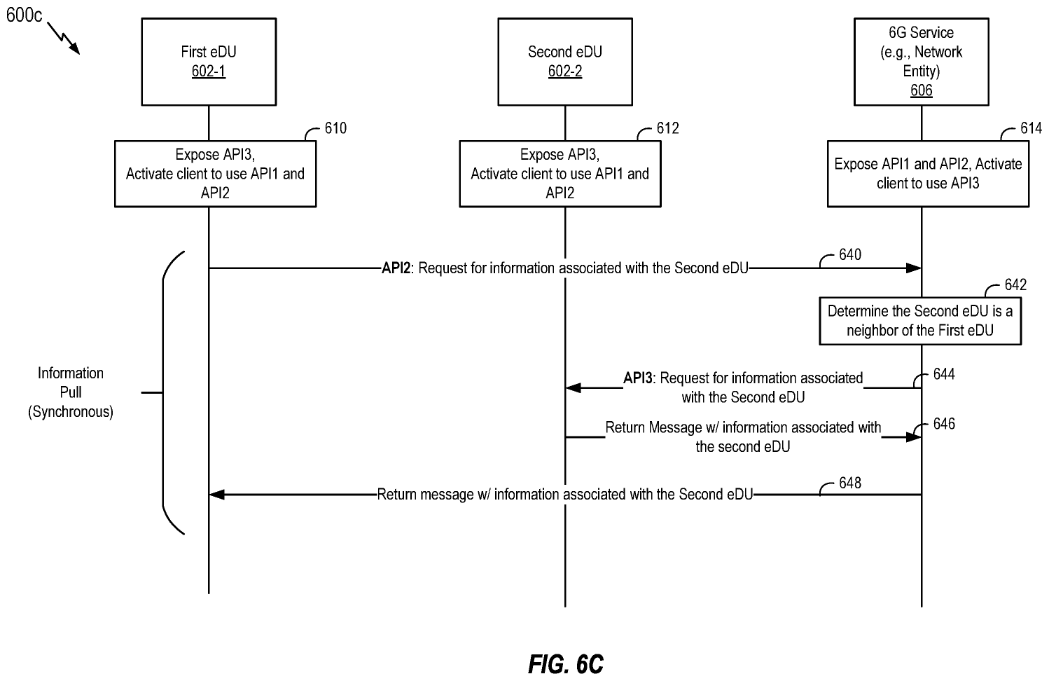

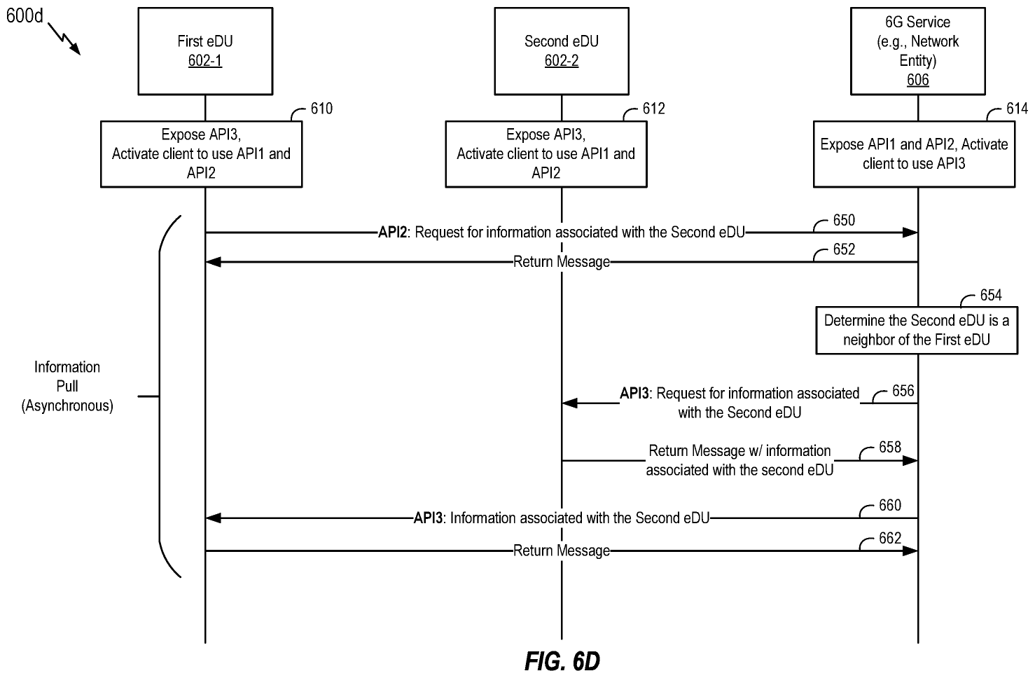

In FIG. 5A, eDUs 502 communicate with one another via APIs exposed at eDUs 502 and one or more 6G service(s) 506. For example, 6G service 506-1 exposes API1 and API2. Evolved DU 502-1, eDU 502-2, and eDU 502-3 may each communicate with 6G service 506-1, via API1 exposed at 6G service 506-1, to register eDU 502-1, eDU 502-2, and eDU 502-3 with 6G service 506-1. Evolved DU 502-1, eDU 502-2, and eDU 502-3 may register with 6G service 506-1 to receive call-back(s) from 6G service 506-1 about information associated with the other eDU(s) (e.g., peer eDU(s)), after such information is received by 6G service 506-1 from the other eDU(s). In particular, each eDU 502 may expose API3, which may be used by 6G service 506-1 to push information to each eDU 502. For example, after registering with 6G service 506-1, eDU 502-1 may use API2 exposed at 6G service 506-1 to send information about eDU 502-1 to 6G service 506-1. Based on receiving this information, 6G service 506-1 may use API3 exposed at eDU 502-2 and API3 exposed at eDU 502-3 to send the information associated with eDU 502-1 to eDU 502-2 and eDU 502-3, respectively. Further, in some cases, 6G service 506-1 uses API3, exposed at eDU 502-1, eDU 502-2, and/or eDU 502-3, to request information from each eDU 502 respectively. This requested information may then be communicated to one or more of the eDUs 502 using API3 exposed at each of the one or more eDUs 502. As such, in FIG. 5A, 6G services 506 are used as relays to communicate information between eDUs 502. Additional details regarding inter-eDU communication using a 6G service as a relay are provided in FIGS. 6A-6D.

Alternatively, in FIG. 5B, eDUs 502 directly communicate with one another via APIs exposed at eDUs 502. For example, as shown, eDU 502-1, eDU 502-2, and eDU 502-3 may each expose API1, API2, and/or API3. Evolved DU 502-1 may expose API2 to enable eDU 502-2 and/or eDU 502-3 to communicate directly with eDU 502-1. For example, eDU 502-1 may expose API2 to enable eDU 502-2 to (1) push information about eDU 502-2 to eDU 502-1 and/or (2) receive a request to send information about a peer eDU, such as eDU 502-3, to eDU 502-2. Further, eDU 502-1 may expose API3 to enable eDU 502-2 to (1) push information about a peer eDU, such as eDU 502-3, to eDU 502-1 and/or (2) receive a request to send information about a peer eDU, such as eDU 502-3, to eDU 502-2. API2 and/or API3, exposed at eDU 502-1, may also be used by eDU 502-3 to exchange similar information, and API2 and/or API3, exposed at eDU 502-2 and/or eDU 502-3, may also be used by the eDUs to exchange similar information.

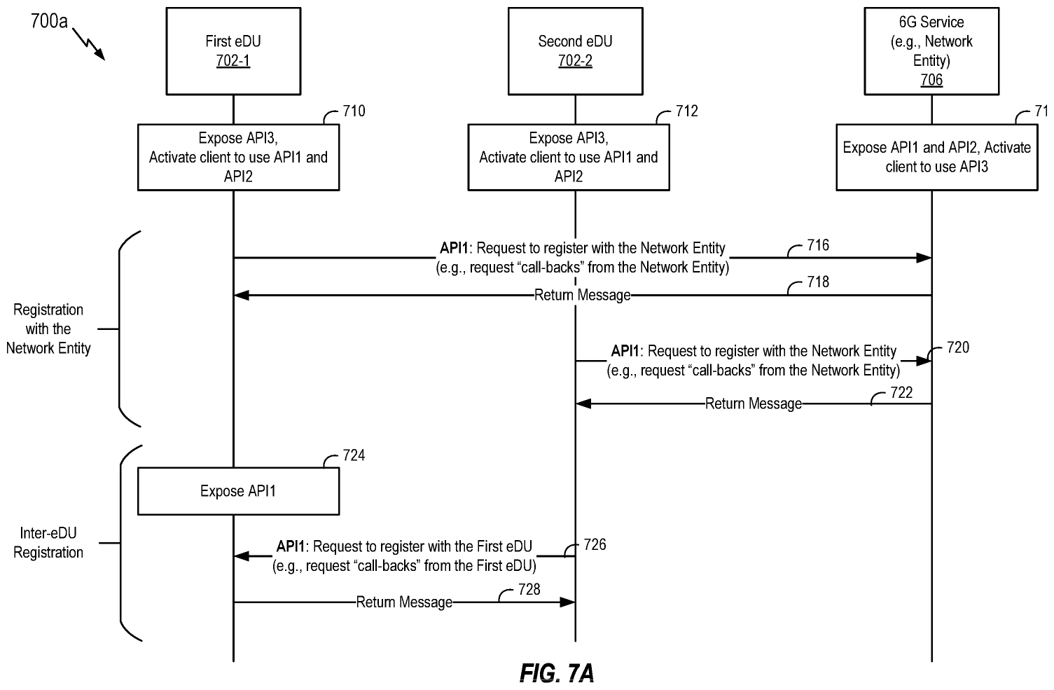

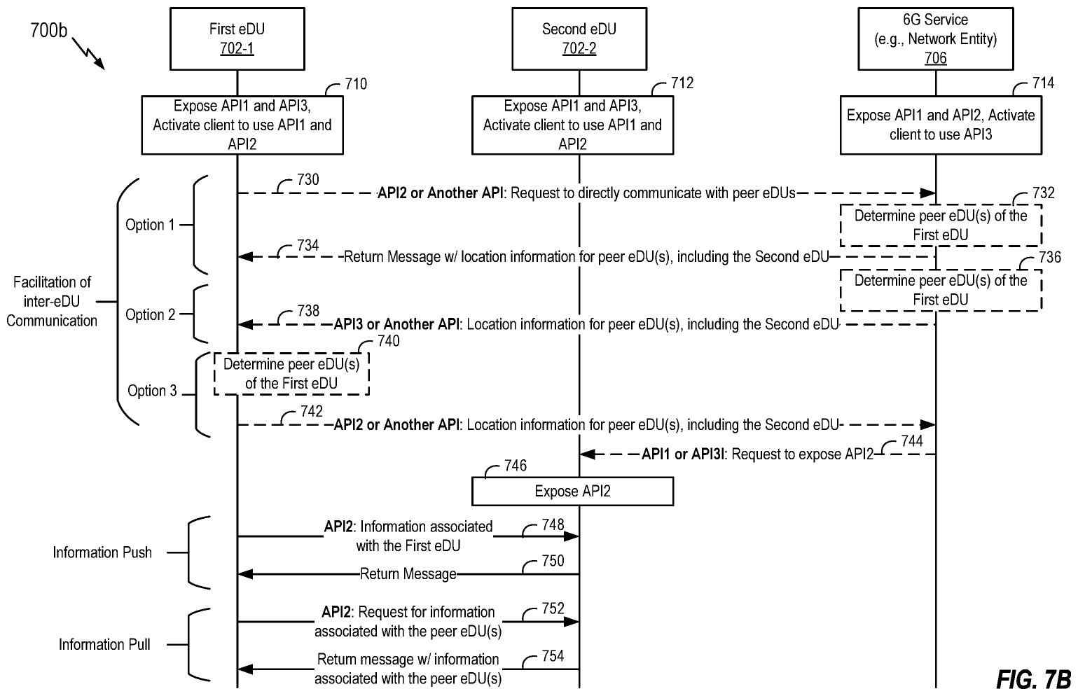

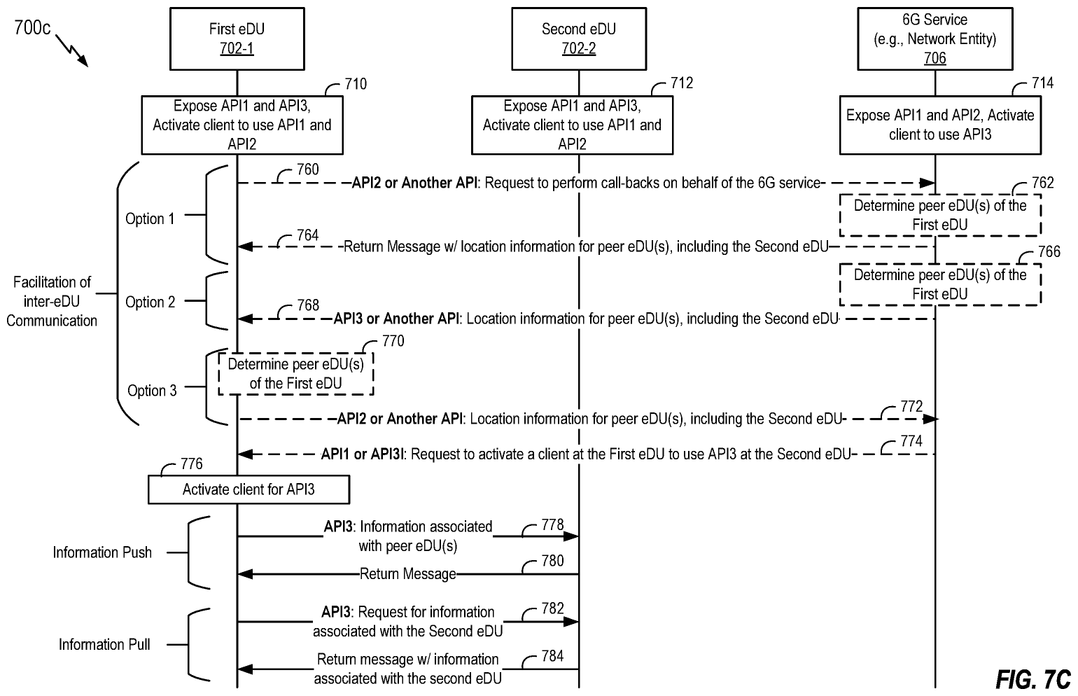

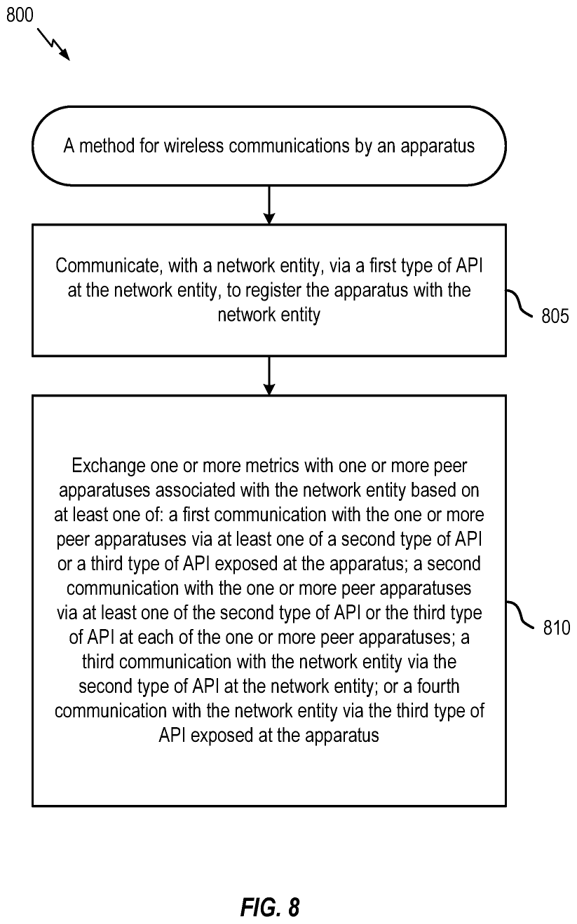

Additionally, API1 exposed at eDU 502-1, may allow eDU 502-2 and/or eDU 502-3 to register with eDU 502-1. eDU 502-2 and/or eDU 502-3 may register with eDU 502-1 to request call-back(s) from eDU 502-1 with information about eDU 502-3 and/or eDU 502-2, respectively. As such, in FIG. 5B, the communication of information is directly between eDUs, without the use of 6G service(s) as relay(s). Additional details regarding such direct inter-eDU communications are provided in FIGS. 7A-7C.

In certain aspects, APIs exposed and/or used by 6G services 506 and eDUs 502 in FIGS. 5A and 5B (e.g., for the exchange of information) may be used together to allow for both direct inter-eDU communications and inter-eDU communications via relaying. In certain other aspects, however, APIs exposed and/or used by 6G services 506 and eDUs 502 may be used only for inter-eDU communications via relaying, as shown in FIG. 5A. Further, in certain aspects, APIs exposed and/or used by 6G services 506 and eDUs 502 may be used only for direct inter-eDU communications, as shown in FIG. 5B.

In certain aspects, API(s) exposed by one eDU may not be the same API(s) exposed by another eDU. For example, eDU 502-1 may expose API1, API2, and API3, while eDU 502-2 may expose only API3. Additionally, client(s) activated at one eDU, to use API(s) at other eDU(s) for the exchange of information, may not be the same as client(s) activated at another eDU.

### Example Operations of Entities in a Communications Network for Inter-eDU Communications Using Relaying Techniques

FIGS. 6A-6D depict process flows 600a-d for communications in a network between a first eDU 602-1, a second eDU 602-2, and a 6G service 606. In some aspects, the first eDU 602-1 and second eDU 602-2 may each be an example of a network entity, such as the BS 102 depicted and described with respect to FIGS. 1 and 3 and/or DU 230 depicted and described with respect to FIG. 2. 6G service 606 may be an example of a network entity, such as a CN NF, such as an AMF, an SMF, a PCF, etc. However, in other aspects, first eDU 602-1, second eDU 602-2, and 6G service 606 may be another type of network entity or network node, such as those described herein. In certain aspects, first eDU 602-1, second eDU 602-2, and 6G service 606 are each deployed in a 6G wireless network where the RAN and one or more CNs are implemented as an SBA.

Though FIGS. 6A-6D are discussed herein with respect to eDUs as example peer apparatuses, CN NFs (e.g., deployed as services, such as 6G services) as example network entities configured to provide services, and SBIs as interfaces for ease of illustration, it should be noted that the techniques described in FIGS. 6A-6D may be similarly used with other peer apparatuses, network entities, and interfaces. Further, though FIGS. 6A-6D are described with respect to a 6G wireless network, the techniques described in FIGS. 6A-6D may be applied to other generations of wireless networks.

Process flows 600a-d in FIGS. 6A-6D depict example inter-eDU communications using relaying techniques as well as API1, API2, and API3. For example, 6G service 606 may be leveraged as a relay to exchange information between first eDU 602-1 and second eDU 602-2. In certain aspects, 6G service 606 is used to provide information associated with first eDU 602-1 to second eDU 602-2. In certain aspects, 6G service 606 is used to provide information associated with second eDU 602-2 to first eDU 602-1.

FIG. 6A depicts example registration of first eDU 602-1 and second eDU 602-2 with 6G service 606 to enable the exchange of information between first eDU 602-1 and second eDU 602-2. FIG. 6B depicts an example information push between first eDU 602-1 and second eDU 602-2 using 6G service 606 as a relay. FIGS. 6C and 6D depict example information pulls to obtain information requested by first eDU 602-1. Although FIGS. 6A-6D depict example signaling between first eDU 602-1, second eDU 602-2, and 6G service 606 to enable inter-eDU communications, in certain aspects, only some of the signaling shown (e.g., less than all signaling) is used for inter-eDU communications. For example, first eDU 602-1, second eDU 602-2, and 6G service 606 may perform signaling shown in FIG. 6B to exchange information between first eDU 602-1 and second eDU 602-2 and may not perform signaling shown in FIGS. 6C and 6D.

As shown in FIGS. 6A-6D, to enable the exchange of information between first eDU 602-1 and second eDU 602-2, first eDU 602-1 may expose API3 at first eDU 602-1 and activate clients to use API1 and API2 at 6G service 606 (e.g., shown at 610). Similarly, second eDU 602-2 may expose API3 at second eDU 602-2 and activate clients to use API1 and API2 at 6G service 606 (e.g., shown at 612). Further, 6G service 606 may expose API1 and API2 at 6G service 606 and activate clients to use API3 at first eDU 602-1 and API3 at second eDU 602-2 (e.g., shown at 614). Although FIGS. 6A-6D, depict both first eDU 602-1 and second eDU 602-2 exposing API3 and activating clients to use API1 and API2 at 6G service 606, as well as 6G service exposing API1 and API2 and activating clients to use API3 at first eDU 602-1 and second eDU 602-2, in some other examples, less than all of these APIs are exposed and/or less than all of these clients are activated at first eDU 602-1, second eDU 602-2, and/or 6G service 606 to enable the exchange of information between eDUs 602.

As shown in FIG. 6A, first eDU 602-1 and second eDU 602-2 may each communicate with 6G service 606, via API1 exposed at 6G service 606, to register first eDU 602-1 and second eDU 602-2 with 6G service 606. For example, at 616, first eDU 602-1 may request to register with 6G service 606, using API1 exposed at 6G service 606. In other words, first eDU 602-1 may request call-backs from 6G service 606 about information associated with peer eDU(s) of first eDU 602-1, such as second eDU 602-2, after such information is received by 6G service 606.

In certain aspects, the request sent to 6G service 606, at 616, includes an identifier associated with first eDU 602-1. In certain aspects, 6G service 606 stores the identifier associated with first eDU 602-1. In certain aspects, the identifier associated with first eDU 602-1 may include an FQDN, an IP address, a geolocation, and/or an ID number of first eDU 602-1. In certain aspects, the identifier associated with first eDU 602-1 may include a cell ID of the client activated at first eDU 602-1 used to communicate with 6G service 606 (e.g., via API1 exposed at 6G service 606) and send the request at 616. In certain aspects, the identifier associated with first eDU 602-1 may include an ID (e.g., URL, domain name, etc.) associated with first eDU 602-1 that is resolvable to an IP address of first eDU 602-1 via a location service, such as a domain name system (DNS) (e.g., used to transform domain names into IP addresses) and/or network repository function (NRF). As such, in some cases (not shown in FIG. 6A), 6G service 606 may need to resolve an ID to determine an IP address associated with first eDU 602-1.

6G service 606 may respond to the request from first eDU 602-1 by sending a return message at 618. The return message may indicate, to first eDU 602-1, that first eDU 602-1 has been successfully registered with 6G service 606, and thus may receive call-backs from 6G service 606. In certain aspects, the return message, sent at 618 in response to the API1 call at 616 from first eDU 602-1, includes a token (e.g., unique token). The token included in the return message may indicate a successful registration of first eDU 602-1 at 6G service 606. The token may be stored at 6G service 606. First eDU 602-1 may later use this token when communicating with 6G service 606. For example, first eDU 602-1 may include the token in a message and/or request sent to 6G service 606, using API2 exposed at 6G service 606. The token may be used by 6G service 606 to identify that the message and/or request is associated with first eDU 602-1.

Similarly, as shown in FIG. 6A, second eDU 602-2 may also register with 6G service 606. For example, at 620, second eDU 602-2 may request to register with 6G service 606, using API1 exposed at 6G service 606. In other words, second eDU 602-2 may request call-backs from 6G service 606 about information associated with peer eDU(s) of second eDU 602-2, such as first eDU 602-1, after such information is received by 6G service 606. 6G service 606 may send, at 622, a return message to second eDU 602-2 in response to receiving the request at 620. The return message may indicate that second eDU 602-2 is registered at 6G service 606.

In certain aspects, prior to communicating with 6G service 606 (e.g., to request registration), first eDU 602-1 and/or second eDU 602-2 may discover 6G service 606 using a discovery procedure. For example, first eDU 602-1 and/or second eDU 602-2 may discover 6G service 606 using DNS (e.g., defined by Internet Engineering Task Force (IETF)) and/or NRF (e.g., defined by 3GPP).

After registering with 6G service 606, communication of information between first eDU 602-1 and second eDU 602-2 may begin. For example, in certain aspects, first eDU 602-1 pushes information to 6G service 606, which is then communicated to second eDU 602-2 (e.g., as shown in FIG. 6B). The information may include one or more metrics associated with first eDU 602-1, such as a cell resource, an air-interface resource, a load, a cell load, an amplifier load, a measurement on a physical channel, a signal strength value, an interference value, a configuration, a TA value, a timestamp, a paging indication, and/or UE-specific information, to name a few. Further, in certain aspects, second eDU 602-2 pushes information to 6G service 606, which is then communicated to first eDU 602-1. The information may also include one or more metrics associated with second eDU 602-2, such as a cell resource, an air-interface resource, a load, a cell load, an amplifier load, a measurement on a physical channel (e.g., channel quality measurement(s), channel congestion level measurement(s), etc.), a signal strength value, an interference value, a configuration, a TA value, a timestamp, a paging indication, and/or UE-specific information, to name a few.

For example, in FIG. 6B, at 630, first eDU sends information associated with first eDU 602-1 to 6G service 606 using API2 exposed at 6G service 606. At 632, 6G service 606 sends first eDU 602-1 a return message indicating that 6G service received the information sent by first eDU 602-1.

In certain aspects, the information sent at 630, to 6G service 606, includes a token received in the return message of a call to API1 exposed at 6G service 606 (e.g., when registering with 6G service 606). 6G service 606 may identify that the information is from first eDU 602-1 and/or is associated with first eDU 602-1 based on comparing the token included in the information to a token stored at 6G service 606.

After receiving the information from first eDU 602-1, 6G service 606 determines, at 634, peer eDU(s) (e.g., neighbor eDU(s)) of first eDU 602-1. As described herein, 6G service 606 may determine peer eDU(s) of first eDU 602-1 based on one or more criteria. In certain aspects, 6G service 606 determines peer eDU(s) of first eDU 602-1 based on identifiers associated with eDUs registered with 6G service 606. For example, at 634 in FIG. 6B, 6G service 606 determines that second eDU 602-2 is a peer (e.g., neighbor) of first eDU 602-1 based on an identifier associated with second eDU 602-2, such as a location of second eDU 602-2, received by 6G service 606 when second eDU 602-2 requested to register with 6G service 606 (e.g., as shown in FIG. 6A). In particular, the information associated with first eDU 602-1 and sent to 6G service 606 at 630 may include information about a location (e.g., a network location and/or a geographic location) of first eDU 602-1. Using this location information for first eDU 602-1 and the location information associated with second eDU 602-2, 6G service 606 may determine that second eDU 602-2 is a peer eDU of first eDU 602-1.

Based on determining that second eDU 602-2 is a peer of first eDU 602-1 and the request of second eDU 602-2 to receive call-backs from 6G service 606 (e.g., during registration depicted in FIG. 6A), 6G service 606 may send, at 636, the information associated with first eDU 602-1 (e.g., received at 630) to second eDU 602-2. 6G service 606 may send this information using API3 exposed at second eDU 602-2. Based on receiving the information associated with first eDU 602-1, second eDU 602-2 may send a return message to 6G service 606, at 638. The return message may indicate that second eDU 602-2 has successfully received the information from 6G service 606.

In certain aspects, 6G service 606 sends the information associated with first eDU 602-1 (e.g., peer eDU information) to second eDU 602-2, at 636, based on one or more trigger events being met. Example trigger events may include a load level (e.g., of a peer eDU, a cell, etc.) reaching a threshold load level, the reception of a report from a UE, a UE connecting to an eDU, a UE disconnecting from an eDU, and/or the like. In certain aspects, the one or more trigger events are related to the metrics shared between 6G service 606, first eDU 602-1, second eDU 602-2, other eDU(s), and/or other 6G service(s). In certain aspects, 6G service 606 sends the information associated with first eDU 602-1 (e.g., peer eDU information) to second eDU 602-2 periodically (e.g., configured to send peer eDU information periodically).

Thus, in FIG. 6B, second eDU 602-2 may receive information associated with first eDU 602-1, thereby allowing for inter-eDU communications. Second eDU 602-2 may operate based on the information exchanged between first eDU 602-1 and second eDU 602-2. For example, the information received by second eDU 602-2 may include information about a reference signal received power (RSRP) measured at a cell associated with first eDU 602-1. Second eDU 602-2 may use this information to determine whether to handover a UE (e.g., connected to the second eDU 602-2 to the cell (e.g., a target cell) associated with first eDU 602-1.

The communication of information between first eDU 602-1 and second eDU 602-2 may additionally or alternatively include 6G service 606 pulling information from first eDU 602-1 and relaying this information to second eDU 602-2 and/or pulling information from second eDU 602-2 and relaying this information to first eDU 602-1.

In certain aspects, the pull of information from first eDU 602-1 and/or from second eDU 602-2 may be performed in response to a request received from second eDU 602-2 and/or first eDU 602-1, respectively, for such information (e.g., synchronous information pull) (e.g., using API2 exposed at 6G service 606). For example, a return message in response to the request from first eDU 602-1 or second eDU 602-2, sent by 6G service 606, may include the requested information. This is referred to herein as a “synchronous” information pull and is described in detail in FIG. 6C.

In certain other aspects, the pull of information from first eDU 602-1 and/or from second eDU 602-2 occurs periodically and/or based on a certain trigger event. As such, the information pulled from first eDU 602-1 is pushed to second eDU 602-2 using API3 exposed at second eDU 602-2 and/or the information pulled from second eDU 602-2 is pushed to first eDU 602-1 using API3 exposed at first eDU 602-1. This is referred to herein as an “asynchronous” information pull and is described in detail in FIG. 6D.

In FIG. 6C, at 640, first eDU 602-1 requests information associated with peer eDUs of first eDU 602-1 (e.g., such as second eDU 602-2 from 6G service 606 using API2 exposed at 6G service 606. At 642, 6G service 606 determines that second eDU 602-2 is a peer eDU of first eDU 602-1 based on one or more criteria. Accordingly, at 644, 6G service 606 requests information associated with second eDU 602-2 from second eDU 602-2 using API3 exposed at second eDU 602-2. In response to the API3 call from 6G service 606, second eDU 602-2 sends, at 646, a return message to 6G service 606 including the requested information.

At 648, 6G service 606 sends a return message to first eDU 602-1 in response to the request, from first eDU 602-1, sent to 6G service 606 at 640. The return message includes information associated with second eDU 602-2 (e.g., obtained at 646).

Similar to FIG. 6C, in FIG. 6D, first eDU 602-1 requests, at 650, information associated with peer eDU(s) of first eDU 602-1 (e.g., such as second eDU 602-2 from 6G service 606 using API2 exposed at 6G service 606. However, instead of the request triggering the pull of information from peer eDU(s) of first eDU (e.g., from second eDU 602-2), 6G service 606 sends, at 652, a return message to first eDU 602-1 acknowledging its request.

At 654, 6G service 606 determines that second eDU 602-2 is a peer eDU of first eDU 602-1 based on one or more criteria. At 656, 6G service 606 requests information associated with second eDU 602-2 from second eDU 602-2 using API3 exposed at second eDU 602-2. In certain aspects, when 6G service 606 calls API3 at second eDU 602-2 to request information associated with second eDU 602-2, 6G service 606 includes in its request an identifier of second eDU 602-2 (e.g., a FQDN, an IP address, a geolocation, etc.) and/or an identifier associated with 6G service 606. In certain aspects, 6G service 606 requests information associated with second eDU 602-2 from second eDU 602-2 using API3 exposed at second eDU 602-2 based on one or more trigger events being met. In certain aspects, 6G service 606 is periodically configured to request information associated with second eDU 602-2 from second eDU 602-2 using API3exposed at second eDU 602-2. In response to the API3 call from 6G service 606, second eDU 602-2 sends, at 658, a return message to 6G service 606 including the requested information.

At 660, 6G service 606 sends the information associated with second eDU 602-2 (e.g., peer eDU information obtained at 658) to first eDU 602-1 using API3 exposed at first eDU 602-1. In certain aspects, 6G service 606 sends the information associated with second eDU 602-2 (e.g., peer eDU information obtained at 658) to first eDU 602-1 using API3 exposed at first eDU 602-1 based on one or more trigger events being met. In certain aspects, 6G service 606 is periodically configured to send the information associated with second eDU 602-2 (e.g., peer eDU information obtained at 658) to first eDU 602-1 using API3 exposed at first eDU 602-1. At 662, first eDU 602-1 sends a return message to 6G service 606 in response to receiving the information associated with second eDU 602-2.

### Example Operations of Entities in a Communications Network for Direct Inter-eDU Communications

FIGS. 7A-7C depict process flows 700a-c for communications in a network between a first eDU 702-1, a second eDU 702-2, and a 6G service 706. In some aspects, the first eDU 702-1 and second eDU 702-2 may each be an example of a network entity, such as the BS 102 depicted and described with respect to FIGS. 1 and 3 and/or DU 230 depicted and described with respect to FIG. 2. 6G service 706 may be an example of a network entity, such as a CN NF, such as an AMF, an SMF, a PCF, etc. However, in other aspects, first eDU 702-1, second eDU 702-2, and 6G service 706 may be another type of network entity or network node, such as those described herein. In certain aspects, first eDU 702-1, second eDU 702-2, and 6G service 706 are each deployed in a 6G wireless network where the RAN and one or more CNs are implemented as an SBA.

Though FIGS. 7A-7C are discussed herein with respect to eDUs as example peer apparatuses, CN NFs (e.g., deployed as services, such as 6G services) as example network entities configured to provide services, and SBIs as interfaces for ease of illustration, it should be noted that the techniques described in FIGS. 7A-7C may be similarly used with other peer apparatuses, network entities, and interfaces. Further, though FIGS. 7A-7C are described with respect to a 6G wireless network, the techniques described in FIGS. 7A-7C may be applied to other generations of wireless networks.

Process flows 700a-c in FIGS. 7A-7C depict example direct inter-eDU communications using API1, API2, and API3. For example, first eDU 702-1 may expose API2 and/or API3 at first eDU 702-1, and second eDU 702-2 may use API2 and/or API3 at first eDU 702, to exchange information directly between first eDU 702-1 and second eDU 702-2. Further, second eDU 702-2 may expose API2 and/or API3 at second eDU 702-2, and first eDU 702-1 may use API2 and/or API3 at second eDU 702, to exchange information directly between second eDU 702-2 and first eDU 702-1. To facilitate such communication between first eDU 702-1 and second eDU 702-2, in certain aspects, 6G service 706 may provide first eDU 702-1 with a list of peer eDU(s), including second eDU 702-2, and/or provide second eDU 702-2 with a list of peer eDU(s), including first eDU 702-1, that may used as proxy(ies) of 6G service 706 for direct communications. In certain aspects, to facilitate direct communication between first eDU 702-1 and second eDU 702-2, 6G service 706 may provide first eDU 702-1 with a call-back location of second eDU 702-2 and/or provide second eDU 702-2 with a call-back location of first eDU 702-1 to enable to first eDU 702-1 and/or second eDU 702-2 to perform call-backs to second eDU 702-2 and/or first eDU 702-1, respectively, on behalf of 6G service 706.

In certain aspects, first eDU 702-1 may expose API1 at first eDU 702-1 to allow second eDU 702-2 to directly register with first eDU 702-1, such that second eDU 702-2 receives call-backs from first eDU 702-1 about information associated with peer eDU(s) of second eDU 702-2. Similarly, in certain aspects, second eDU 702-2 may expose API1 at second eDU 702-2 to allow first eDU 702-1 to directly register with second eDU 702-2, such that first eDU 702-1 receives call-backs from second eDU 702-2 about information associated with peer eDU(s) of first eDU 702-1.

For example, FIG. 7A depicts (1) example registration of first eDU 702-1 with 6G service 706 and/or second eDU 702-2 and/or (2) example registration of second eDU 702-2 with 6G service 706 and/or first eDU 702-1 to enable the direct exchange of information between first eDU 702-1 and second eDU 702-2. FIG. 7B depicts example information exchange directly between first eDU 702-1 and second eDU 702-2, using API2 exposed at second eDU 702-2 and a client activated at first eDU 702-1 to use API2 exposed at second eDU 702-2. Further, FIG. 7C depicts example information exchange directly between first eDU 702-1 and second eDU 702-2, using API3 exposed at second eDU 702-2 and a client activated at first eDU 702-1 to use API3 exposed at second eDU 702-2.

As shown in FIGS. 7A-7C, to enable the exchange of information between first eDU 702-1 and second eDU 702-2, first eDU 702-1 may expose API3 at first eDU 702-1 and activate clients to use API1 and API2 at 6G service 706 (e.g., shown at 710). Similarly, second eDU 702-2 may expose API3 at second eDU 702-2 and activate clients to use API1 and API2 at 6G service 706 (e.g., shown at 712). Further, 6G service 706 may expose API1 and API2 at 6G service 706 and activate clients to use API3 at first eDU 702-1 and API3 at second eDU 702-2 (e.g., shown at 714). Although FIGS. 7A-7C, depict both first eDU 702-1 and second eDU 702-2 exposing API3 and activating clients to use API1 and API2 at 6G service 706, as well as 6G service exposing API1 and API2 and activating clients to use API3 at first eDU 702-1 and second eDU 702-2, in some other examples, less than all of these APIs are exposed and/or less than all of these clients are activated at first eDU 702-1, second eDU 702-2, and/or 6G service 706 to enable the exchange of information between eDUs 702.

Further, in certain aspects, first eDU 702-1 may expose API2 at first eDU 702-1 and/or second eDU 702-2 may expose API2 at second eDU 702-2, for example, as shown in FIG. 7B. In certain aspects, first eDU 702-1 may activate a client to use API3 exposed at second eDU 702-2 and/or second eDU 702-2 may activate a client to use API3 exposed at first eDU 702-1, for example, as shown in FIG. 7C.

As shown in FIG. 7A, in certain aspects, first eDU 702-1 and second eDU 702-2 may each communicate with 6G service 706, via API1 exposed at 6G service 706, to register first eDU 702-1 and second eDU 702-2 with 6G service 706.

For example, at 716, first eDU 702-1 may request to register with 6G service 706, using API1 exposed at 6G service 706. 6G service 706 may respond to the request from first eDU 702-1 by sending a return message at 718. The return message may indicate, to first eDU 702-1, that first eDU 702-1 has been successfully registered with 6G service 706, and thus may receive call-backs from 6G service 706. Signaling 716 and 718, shown in FIG. 7A, used to register first eDU 702-1 with 6G service 706 may be similar to signaling 616 and 618 shown in FIG. 6A.

Further, at 720, second eDU 702-2 may request to register with 6G service 706, using API1 exposed at 6G service 706. 6G service 706 may respond to the request from second eDU 702-2 by sending a return message at 722. The return message may indicate, to second eDU 702-2, that second eDU 702-2 has been successfully registered with 6G service 706, and thus may receive call-backs from 6G service 706. Signaling 720 and 722, shown in FIG. 7A, used to register second eDU 702-2 with 6G service 706 may be similar to signaling 620 and 622 shown in FIG. 6A.

In certain aspects, prior to communicating with 6G service 706 (e.g., to request registration), first eDU 702-1 and/or second eDU 702-2 may discover 6G service 706 using a discovery procedure.

In addition to, or alternative to registering with 6G service 706, first eDU 702-1 may register with second eDU 702-2 and/or second eDU 702-2 may register with first eDU 702-1. For example, FIG. 7A illustrates second eDU 702-2 registering with first eDU 702-1 to receive call-backs from first eDU 702-1 about peer eDU(s) of second eDU 702-2. At 724, first eDU 702-1 exposes API1 at first eDU 702-1 to allow other eDU(s) to register with first eDU 702-1. In certain aspects, first eDU 702-1 exposes API1 based on a receiving a request from 6G service 706 requesting that first eDU 702-1 expose API1 at first eDU 702-1 (e.g., not shown in FIG. 7A).

At 726, second eDU 702-2 requests to register with first eDU 702-1, using API1 exposed at first eDU 702-1 (and a client activated at second eDU 702-2 used to call API1 at first eDU 702-1). In certain aspects, second eDU 702-2 registers with first eDU 702-1 based on receiving a request from 6G service 706 requesting that second eDU 702-2 register with first eDU 702-1.

First eDU 702-1 may respond to the request from second eDU 702-2 by sending a return message at 728. The return message may indicate, to second eDU 702-2, that second eDU 702-2 has been successfully registered with first eDU 702-1, and thus may receive call-backs from first eDU 702-1.

After registration of first eDU 702-1 and second eDU 702-2 with 6G service 706, direct inter-eDU communications between first eDU 702-1 and second eDU 702-2 may be facilitated by 6G service 706.

For example, to allow for the direct communication of information between first eDU 702-1 and second eDU 702-2, 6G service 706 may provide first eDU 702-1 with a list of peer eDU(s) of first eDU 702-1, including second eDU 702-2, for direct inter-eDU communications. Further, 6G service 706 may provide second eDU 702-2 with a list of peer eDU(s) of second eDU 702-2, including first eDU 702-1, that may be used for direct inter-eDU communications. 6G service 706 providing first eDU 702-1 with a list of peer eDU(s) is shown in FIG. 7B.

For example, as shown in a first option in FIG. 7B, first eDU 702-1 sends, at 730, a request to 6G service 706, requesting to directly communicate with peer eDU(s) of first eDU 702-1. First eDU 702-1 sends the request using API2 exposed at 6G service 706 and/or another API exposed at 6G service 706. Based on receiving the request, 6G service 706 determines one or more peer eDUs of first eDU 702-1 and sends location information (e.g., FQDN(s), IP address(es), etc.) for the determined peer eDU(s) to first eDU 702-1, at 732 and 734 respectively. In certain aspects, 6G service 706 identifies multiple peer eDUs of first eDU 702-1 and sends location information for the multiple eDUs to first eDU 702-1, at 732 and 734 respectively. The location information may be included in a return message sent in response to receiving the request via API2 exposed at 6G service 706. The location information may include location information for at least second eDU 702-2, e.g., a determined peer eDU of first eDU 702-1. First eDU 702-1 may use the location information of its peer eDU(s) to directly communicate with the peer eDU(s) (e.g., conduct API calls to its peer eDU(s) for the exchange of information).

In a second option shown in FIG. 7B, instead of first eDU 702-1 sending a request to 6G service 706 requesting to directly communicate with peer eDU(s) of first eDU 702-1 and in response receiving location information of its peer eDU(s), 6G service 706 may send the location information for peer eDU(s) of first eDU 702-1 without first receiving a request. For example, to enable direct inter-eDU communications between first eDU 702-1 and second eDU 702-2, 6G service 706 determines peer eDU(s) of first eDU 702-1 at 736. At 738, 6G service 706 sends the location information for the determined peer eDU(s) to first eDU 702-1. 6G service 706 sends the location information to first eDU 702-1 using API3 and/or another API exposed by first eDU 702-1. 6G service 706 may determine and send location information of peer eDU(s) to first eDU 702-1, at 736 and 738 respectively, to request that first eDU 702-1 communicate directly with peer eDU(s) of first eDU 702-1. In this example, 6G service 706 may determine that second eDU 702-2 is a peer eDU of first eDU 702-1 and send location information associated with second eDU 702-2 to 6G service 706 to request that first eDU 702-1 communicate directly with second eDU 702-2.

In a third option shown in FIG. 7B, instead of 6G service 706 providing first eDU 702-1 with location information for one or more peer eDUs of first eDU 702-1, first eDU 702-1 sends location information for one or more peer eDUs of first eDU 702-1 to 6G service 706. For example, first eDU 702-1 determines peer eDU(s) of first eDU 702-1 at 740. In certain aspects, first eDU 702-1 may make this determination based on identifier information (e.g., location information) associated with eDU(s) registered with first eDU 702-1. At 742, first eDU 702-1 sends the location information for the determined peer eDU(s) to 6G service 706. First eDU 702-1 sends the location information to 6G service 706 using API2 and/or another API exposed by 6G service 706. First eDU 702-1 may determine and send location information of peer eDU(s) to 6G service 706, at 740 and 742 respectively, to request to directly communicate with peer eDU(s) of first eDU 702-1. In this example, first eDU 702-1 may determine that second eDU 702-2 is a peer eDU of first eDU 702-1 and send location information associated with second eDU 702-2 to 6G service 706 to request to directly communicate with second eDU 702-2.

To enable direct communications between first eDU 702-1 and its peer eDU(s), including second eDU 702-2, each of the peer eDUs may need to expose API2. For example, as shown in FIG. 7B at 746, second eDU 702-2 exposes API2 to enable first eDU 702-1 to communicate information directly with second eDU 702-2. In certain aspects, second eDU 702-2 exposes API2 at 746 based on receiving a request, from 6G service 706, to expose API2 at second eDU 702-2. For example, after determining that second eDU 702-2 is a peer eDU of first eDU 702-1 (e.g., options 1 and 2) and/or after receiving location information associated with second eDU 702-2 (e.g. option 3), 6G service 706 may send, at 744 to second eDU 702-2, a request to expose API2 at second eDU 702-2. 6G service 706 may send this request using API1 or API3 exposed at second eDU 702-2. 6G service 706 may send this request to request that second eDU 702-2 act as a proxy for 6G service 706.

Exposing API2 at second eDU 702-2 enables first eDU 702-1 to (1) push information associated with first eDU 702-1 to second eDU 702-2 and/or (2) request information associated with other peer eDU(s) of first eDU 702-1.

For example, at 748, first eDU 702-1 may send information associated with first eDU 702-1 to second eDU 702-2 using API2 exposed by second eDU 702-2. Based on receiving the information, second eDU 702-2 may send a return message to first eDU 702-1 acknowledging receipt of this information, at 750.

As another example, at 752, first eDU 702-1 may send a request for information associated with other peer eDU(s) of first eDU 702-1 to second eDU 702-2. First eDU 702-1 may send the request using API2 exposed by second eDU 702-2. Based on receiving the request, second eDU 702-2 may send a return message to first eDU 702-1 including information associated with peer eDU(s) of first eDU 702-1 to first eDU 702-1 at 754. Information associated with the peer eDU(s) may include information received by second eDU 702-2 about the peer eDU(s) (e.g., via information pushes and/or pulls) from other eDUs (e.g., in some cases, including one or more of the peer eDU(s)) and/or 6G service 706. Information associated with the peer eDU(s) may include information about second eDU 702-2.

In some cases, instead of requesting to directly communicate with peer eDU(s), first eDU 702-1 instead requests to perform call-backs on behalf of 6G service 706. For example, as shown in a first option in FIG. 7C, first eDU 702-1 sends, at 760, a request to 6G service 706, requesting to perform call-backs on behalf of 6G service 706 (e.g., to directly communicate with peer eDU(s) of first eDU 702-1). First eDU 702-1 sends the request using API2 exposed at 6G service 706 and/or another API exposed at 6G service 706. Based on receiving the request, 6G service 706 determines one or more peer eDUs of first eDU 702-1 and sends location information for the determined peer eDU(s) to first eDU 702-1, at 762 and 764 respectively. The location information may be included in a return message sent in response to receiving the request via API2 exposed at 6G service 706. The location information may include location information for at least second eDU 702-2, e.g., a determined peer eDU of first eDU 702-1.

In a second option shown in FIG. 7C, instead of first eDU 702-1 sending a request to 6G service 706 requesting to perform call-backs on behalf of 6G service 706 and in response receiving location information of its peer eDU(s), 6G service 706 may send the location information for peer eDU(s) of first eDU 702-1 without first receiving a request. For example, to enable direct inter-eDU communications between first eDU 702-1 and second eDU 702-2, 6G service 706 determines peer eDU(s) of first eDU 702-1 at 766. At 768, 6G service 706 sends the location information for the determined peer eDU(s) to first eDU 702-1. 6G service 706 sends the location information to first eDU 702-1 using API3 and/or another API exposed by first eDU 702-1. 6G service 706 may determine and send location information of peer eDU(s) to first eDU 702-1, at 766 and 768 respectively, to request that first eDU 702-1 perform call-backs on behalf of 6G service 706 (and specifically, perform call-backs to second eDU 702-2).

In a third option shown in FIG. 7C, instead of 6G service 706 providing first eDU 702-1 with location information for one or more peer eDUs of first eDU 702-1, first eDU 702-1 sends location information for one or more peer eDUs of first eDU 702-1 to 6G service 706. For example, first eDU 702-1 determines peer eDU(s) of first eDU 702-1 at 770. In certain aspects, first eDU 702-1 may make this determination based on identifier information (e.g., location information) associated with eDU(s) registered with first eDU 702-1. At 772, first eDU 702-1 sends the location information for the determined peer eDU(s) to 6G service 706. First eDU 702-1 sends the location information to first eDU 702-1 using API2 and/or another API exposed by 6G service 706. First eDU 702-1 may determine and send location information of peer eDU(s) to 6G service 706, at 770 and 772 respectively, to request to perform call-backs on behalf of 6G service 706 (and specifically, perform call-backs to second eDU 702-2).

To enable first eDU 702-1 to perform call-backs on behalf of 6G service 706, and specifically call-backs to second eDU 702-2, first eDU 702-1 may need to activate a client at first eDU 702-1 to use API3 exposed by second eDU 702-2. For example, as shown in FIG. 7C at 776, first eDU 702-1 activates a client to use API3 at second eDU 702-2. In certain aspects, first eDU 702-1 activates a client to use API3 at second eDU 702-2, at 776, based on receiving a request, from 6G service 706, to activate the client for API3. For example, after determining that second eDU 702-2 is a peer eDU of first eDU 702-1 (e.g., options 1 and 2) and/or after receiving location information associated with second eDU 702-2 (e.g. option 3), 6G service 706 may send, at 774 to first eDU 702(\grave{ }) a request to activate a client to use API3 at second eDU 702-2. 6G service 706 may send this request using API1 or API3 exposed at first eDU 702-1. 6G service 706 may send this request to request that first eDU 702-1 perform call-backs to second eDU 702-2 on behalf of 6G service 706.

Activating a client, at first eDU 702-1, to use API3 at second eDU 702-2 enables first eDU 702-1 to (1) push information associated with peer eDU(s) of second eDU 702-2 to second eDU 702-2 and/or (2) request information associated with second eDU 702-2 from second eDU 702-2.

For example, at 778, first eDU 702-1 may send information associated with peer eDU(s) of second eDU 702-2 (e.g., first eDU 702-1) to second eDU 702-2 using API3 exposed by second eDU 702-2 and the client activated at first eDU 702-1 for API3. Based on receiving the information, second eDU 702-2 may send, at 780, a return message to first eDU 702-1 acknowledging receipt of this information.

As another example, at 782, first eDU 702-1 may send a request for information associated with second eDU 702-2 to second eDU 702-2. First eDU 702-1 may send the request using API3 exposed by second eDU 702-2 and the client activated at first eDU 702-1 for API3. Based on receiving the request, second eDU 702-2 may send a return message to first eDU 702-1 including information associated with second eDU 702-2 to first eDU 702-1 at 784.

In certain aspects, first eDU 702-1 and/or second eDU 702-2 communicate with 6G service 706 to inform 6G service 706 about whether direct inter-eDU communications between first eDU 702-1 and second eDU 702-2 (or with other peer eDU(s)) have been successful or not. For example, first eDU 702-1 and/or second eDU 702-2 may send an indication to 6G service 706 about the successful retrieval of information from peer eDU(s) included in a list of peer eDU(s) associated with first eDU 702-1 and/or second eDU 702-2. In some cases, first eDU 702-1 and/or second eDU 702-2 may inform 6G service 706 that attempted communications with each other (or other peer eDU(s)) have failed, for example, signaling at 748-754 in FIG. 7B and/or signaling at 778-784 in FIG. 7C has failed thereby resulting in an unsuccessful, direct exchange of information between first eDU 702-1 and second eDU 702-2. In certain aspects, based on receiving this information (e.g., indicating failed communications), 6G service 706 may fall back to using itself as a relay to enable communications between first eDU 702-1 and second eDU 702-2 (and/or other peer eDU(s)).

### Example Operations

FIG. 8 shows a method 800 for wireless communications by an apparatus, such as BS 102 of FIGS. 1 and 3, or a disaggregated base station as discussed with respect to FIG. 2.

Method 800 begins at block 805 with communicating, with a network entity, via a first type of API at the network entity, to register the apparatus with the network entity.

Method 800 then proceeds to block 810 with exchanging one or more metrics with one or more peer apparatuses associated with the network entity based on at least one of: a first communication with the one or more peer apparatuses via at least one of a second type of API or a third type of API exposed at the apparatus; a second communication with the one or more peer apparatuses via at least one of the second type of API or the third type of API at each of the one or more peer apparatuses; a third communication with the network entity via the second type of API at the network entity; or a fourth communication with the network entity via the third type of API exposed at the apparatus.

In certain aspects, method 800 further includes sending, to the network entity, via the second type of API at the network entity or a fourth type of API, a request to communicate the one or more metrics directly with the one or more peer apparatuses.

In certain aspects, method 800 further includes receiving a message comprising location information for each of the one or more peer apparatuses.

In certain aspects, the location information for each of the one or more peer apparatuses comprises a FQDN or an IP address.

In certain aspects, method 800 further includes sending, to the network entity, via the second type of API at the network entity or a fourth type of API, a message comprising location information for each of the one or more peer apparatuses.

In certain aspects, the location information for each of the one or more peer apparatuses comprises a FQDN or an IP address.

In certain aspects, method 800 further includes receiving, from the network entity, via the third type of API at the apparatus or a fourth type of API, a message comprising location information for each of the one or more peer apparatuses.

In certain aspects, the location information for each of the one or more peer apparatuses comprises a FQDN or an IP address.

In certain aspects, exchanging the one or more metrics based on the first communication with the one or more peer apparatuses via at least one of the second type of API or the third type of API exposed at the apparatus comprises: receiving, directly from a first peer apparatus of the one or more peer apparatuses, via the second type of API or the third type of API, a request for at least one metric of the one or more metrics; and sending, directly to the first peer apparatus, the at least one metric in a return message to the request.

In certain aspects, the at least one metric comprises: information associated with the apparatus; or information associated with at least one peer apparatus associated with the first peer apparatus.

In certain aspects, exchanging the one or more metrics based on the first communication with the one or more peer apparatuses via at least one of the second type of API or the third type of API exposed at the apparatus comprises: receiving, directly from a first peer apparatus of the one or more peer apparatuses, via the second type of API or the third type of API, at least one metric of the one or more metrics.

In certain aspects, the at least one metric comprises: information associated with the first peer apparatus; or information associated with at least one peer apparatus associated with the apparatus.

In certain aspects, exchanging the one or more metrics based on the second communication with the one or more peer apparatuses via at least one of the second type of API or the third type of API at each of the one or more peer apparatuses comprises: sending, directly to a first peer apparatus of the one or more peer apparatuses, via the second type of API or the third type of API at the first peer apparatus, a request for at least one metric of the one or more metrics; and receiving, directly from the first peer apparatus, the at least one metric in a return message to the request.

In certain aspects, the at least one metric comprises: information associated with the first peer apparatus; or information associated with at least one peer apparatus associated with the apparatus.

In certain aspects, exchanging the one or more metrics based on the second communication with the one or more peer apparatuses via at least one of the second type of API or the third type of API at each of the one or more peer apparatuses comprises: sending, directly to a first peer apparatus of the one or more peer apparatuses, via the second type of API or the third type of API at the first peer apparatus, at least one metric of the one or more metrics.

In certain aspects, the at least one metric comprises: information associated with the apparatus; or information associated with at least one peer apparatus associated with the first peer apparatus.

In certain aspects, the one or more metrics comprise information associated with the apparatus; and exchanging the one or more metrics based on the third communication with the network entity via the second type of API at the network entity comprises sending, to the network entity, via the second type of API, the one or more metrics.

In certain aspects, the one or more metrics comprise information associated with at least one of the one or more peer apparatuses associated with the apparatus; and exchanging the one or more metrics based on the third communication with the network entity via the second type of API at the network entity comprises: sending, to the network entity, via the second type of API, a request for the one or more metrics; and receiving, from the network entity, the one or more metrics in a return message to the request.

In certain aspects, the one or more metrics comprise information associated with the apparatus; and exchanging the one or more metrics based on the fourth communication with the network entity viathe third type of API exposed at the apparatus comprises: receiving, from the network entity, via the third type of API, a request for the one or more metrics; and sending, to the network entity the one or more metrics in a return message to the request.

In certain aspects, the one or more metrics comprise information associated with at least one of the one or more peer apparatuses associated with the apparatus; and exchanging the one or more metrics based on the fourth communication with the network entity viathe third type of API at exposed the apparatus comprises receiving, from the network entity, via the third type of API, the one or more metrics.

In certain aspects, communicating, with the network entity, to register the apparatus with the network entity comprises providing the network entity with an identifier associated with the apparatus comprising at least one of: a FQDN; an IP address; a geolocation; an ID number; or a cell ID.

In certain aspects, method 800 further includes discovering the network entity.

In certain aspects, method 800 further includes receiving a token based on a successful registration of the apparatus with the network entity.

In certain aspects, exchanging the one or more metrics via using the second type of API at the network entity comprises sending, to the network entity, via the second type of API, a message comprising the one or more metrics or a request for the one or more metrics, and the message or the request comprises the token.

In certain aspects, exchanging the one or more metrics based on the third communication with the network entity via the second type of API at the network entity comprises sending, to the network entity, via the second type of API, a message comprising the one or more metrics or a request for the one or more metrics, and the message or the request comprises an identifier associated with the apparatus.

In certain aspects, exchanging the one or more metrics based on the first communication with the one or more peer apparatuses via the third type of API exposed at the apparatus comprises receiving, from the network entity, via the third type of API, a message comprising the one or more metrics or a request for the one or more metrics, and the message or the request comprises at least one of an identifier associated with the apparatus or an identifier associated with the network entity.

In certain aspects, exchanging the one or more metrics based on the third communication with the network entity via the second type of API at the network entity or based on the fourth communication with the network entity via the third type of API exposed at the apparatus comprisesexchanging the one or more metrics based on at least one of: a configured periodicity; or a trigger event.

In certain aspects, the one or more peer apparatuses comprise peer apparatuses associated with the network entity that are neighbors of the apparatus based on a location of each of the one or more peer apparatuses.

In certain aspects, the one or more metrics comprise at least one of: a cell resource; an air-interface resource; a cell load; a peer apparatus load; an amplifier load; a measurement on a physical channel; a signal strength value; an interference value; a configuration; a timing advance value; a timestamp; a paging indication; or UE-specific information.

In certain aspects, method 800 further includes receiving, from the network entity, an indication to at least one of: expose at least one of the second type of API or the third type of API at the apparatus; or activate a client at the apparatus to use at least one of the second type of API or the third type of API at each of the one or more peer apparatuses.

In certain aspects, method 800 further includes communicating, with at least one peer apparatus of the one or more peer apparatuses, via the first type of API at the at least one peer apparatus, to register the apparatus with the at least one peer apparatus.

In certain aspects, method 800 further includes receiving, from the network entity, an indication to register the apparatus with the at least one peer apparatus.

In certain aspects, method 800 further includes communicating, with the at least one peer apparatus, to register the apparatus based on the reception of the indication.

In certain aspects, method 800 further includes receiving, from the network entity, an indication to expose the first type of API at the apparatus to enable the one or more peer apparatuses to register with the apparatus.

In certain aspects, method 800 further includes exchanging an identifier associated with the apparatus with the one or more peer apparatuses.

In certain aspects, method 800 further includes sending, to the network entity, an indication that the one or more metrics were successfully exchanged with at least one peer apparatus of the one or more peer apparatuses.

In certain aspects, method 800 further includes sending, to the network entity, an indication that apparatus failed to successfully exchange the one or more metrics with at least one peer apparatus of the one or more peer apparatuses.

In certain aspects, exchanging the one or more metrics based on at least one of the first communication with the one or more peer apparatuses via the second type of API exposed at the apparatus, the first communication with the network entity via the third type of API exposed at the apparatus, the second communication with the one or more peer appratuses via the second type of API at each of the one or more peer apparatuses, or the second communication with the one or more peer appratuses via the third type of API at each of the one or more peer apparatuses, comprises exchanging the one or more metrics based on at least one of: a configured periodicity; or a trigger event.

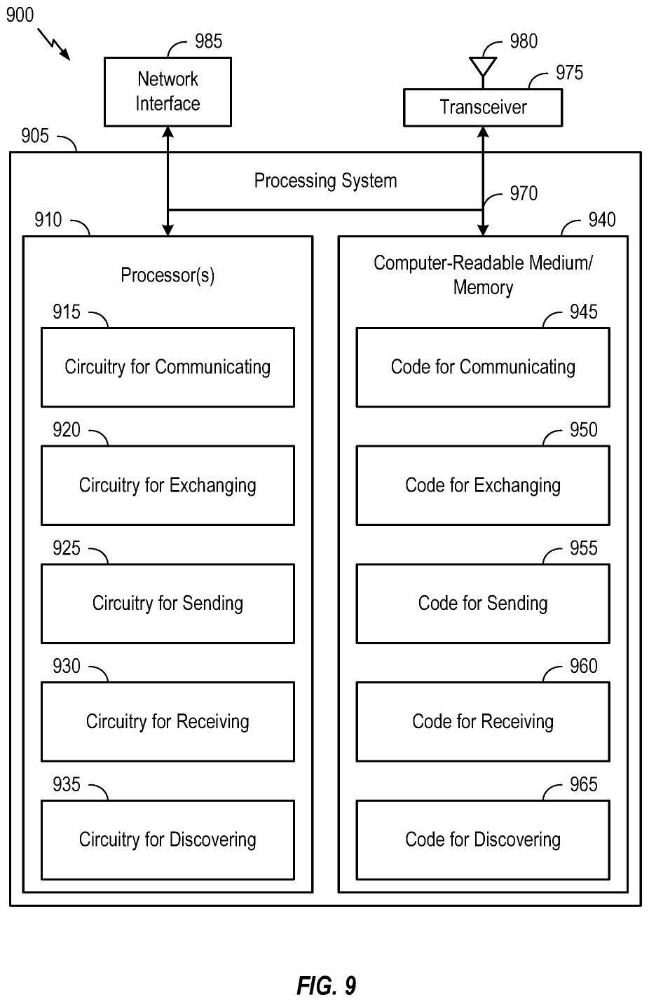

In certain aspects, method 800, or any aspect related to it, may be performed by an apparatus, such as communications device 900 of FIG. 9, which includes various components operable, configured, or adapted to perform the method 800. Communications device 900 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900. In some aspects, communications device 900 is a network entity, such as BS 102 of FIGS. 1 and 3, or a disaggregated base station as discussed with respect to FIG. 2.

The communications device 900 includes a processing system 905 coupled to a transceiver 975 (e.g., a transmitter and/or a receiver) and/or a network interface 985. The transceiver 975 is configured to transmit and receive signals for the communications device 900 via an antenna 980, such as the various signals as described herein. The network interface 985 is configured to obtain and send signals for the communications device 900 via communications link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 940 via a bus 970. In certain aspects, the computer-readable medium/memory 940 is configured to store instructions (e.g., computer-executable code) that when executed by the one or more processors 910, enable and cause the one or more processors 910 to perform the method 800 described with respect to FIG. 8, or any aspect related to it, including any operations described in relation to FIG. 8. Note that reference to a processor of communications device 900 performing a function may include one or more processors of communications device 900 performing that function, such as in a distributed fashion.

In the depicted example, the computer-readable medium/memory 940 stores code for communicating 945, code for exchanging 950, code for sending 955, code for receiving 960, and code for discovering 965. Processing of the code 945-965 may enable and cause the communications device 900 to perform the method 800 described with respect to FIG. 8, or any aspect related to it.

The one or more processors 910 include circuitry configured to implement (e.g., execute) the code stored in the computer-readable medium/memory 940, including circuitry for communicating 915, circuitry for exchanging 920, circuitry for sending 925, circuitry for receiving 930, and circuitry for discovering 935. Processing with circuitry 915-935 may enable and cause the communications device 900 to perform the method 800 described with respect to FIG. 8, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 975, antenna 980, and/or network interface 985 of the communications device 900 in FIG. 9, and/or one or more processors 910 of the communications device 900 in FIG. 9. Means for communicating, receiving or obtaining may include the transceivers 332, antenna(s) 334, receive processor 338, AI processor 318, and/or controller/processor 340 of the BS 102 illustrated in FIG. 3, transceiver 975, antenna 980, and/or network interface 985 of the communications device 900 in FIG. 9, and/or one or more processors 910 of the communications device 900 in FIG. 9.

### Example Clauses

Implementation examples are described in the following numbered clauses:

Clause 1: A method for wireless communications by an apparatus comprising: communicating, with a network entity, via a first type of API at the network entity, to register the apparatus with the network entity; and exchanging one or more metrics with one or more peer apparatuses associated with the network entity based on at least one of: a first communication with the one or more peer apparatuses via at least one of a second type of API or a third type of API exposed at the apparatus; a second communication with the one or more peer apparatuses via at least one of the second type of API or the third type of API at each of the one or more peer apparatuses; a third communication with the network entity via the second type of API at the network entity; or a fourth communication with the network entity via the third type exposed of API.

Clause 2: The method of Clause 1, further comprising: sending, to the network entity, via the second type of API at the network entity or a fourth type of API, a request to communicate the one or more metrics directly with the one or more peer apparatuses; and receiving a message comprising location information for each of the one or more peer apparatuses.

Clause 3: The method of Clause 2, wherein the location information for each of the one or more peer apparatuses comprises a FQDN or an IP address.

Clause 4: The method of Clause 1, further comprising: sending, to the network entity, via the second type of API at the network entity or a fourth type of API, a message comprising location information for each of the one or more peer apparatuses.

Clause 5: The method of Clause 4, wherein the location information for each of the one or more peer apparatuses comprises a FQDN or an IP address.

Clause 6: The method of Clause 1, further comprising: receiving, from the network entity, via the third type of API at the apparatus or a fourth type of API, a message comprising location information for each of the one or more peer apparatuses.

Clause 7: The method of Clause 6, wherein the location information for each of the one or more peer apparatuses comprises a FQDN or an IP address.

Clause 8: The method of any one of Clauses 1-7, wherein exchanging the one or more metrics based on the first communication with the one or more peer apparatuses via at least one of the second type of API or the third type of API exposed at the apparatus comprises: receiving, directly from a first peer apparatus of the one or more peer apparatuses, via the second type of API or the third type of API, a request for at least one metric of the one or more metrics; and sending, directly to the first peer apparatus, the at least one metric in a return message to the request.

Clause 9: The method of Clause 8, wherein the at least one metric comprises: information associated with the apparatus; or information associated with at least one peer apparatus associated with the first peer apparatus.

Clause 10: The method of any one of Clauses 1-9, wherein exchanging the one or more metrics based on the first communication with the one or more peer apparatuses via at least one of the second type of API or the third type of API exposed at the apparatus comprises: receiving, directly from a first peer apparatus of the one or more peer apparatuses, via the second type of API or the third type of API, at least one metric of the one or more metrics.

Clause 11: The method of Clause 10, wherein the at least one metric comprises: information associated with the first peer apparatus; or information associated with at least one peer apparatus associated with the apparatus.

Clause 12: The method of any one of Clauses 1-11, wherein exchanging the one or more metrics based on the second communication with the one or more peer apparatuses via at least one of the second type of API or the third type of API at each of the one or more peer apparatuses comprises: sending, directly to a first peer apparatus of the one or more peer apparatuses, via the second type of API or the third type of API at the first peer apparatus, a request for at least one metric of the one or more metrics; and receiving, directly from the first peer apparatus, the at least one metric in a return message to the request.

Clause 13: The method of Clause 12, wherein the at least one metric comprises: information associated with the first peer apparatus; or information associated with at least one peer apparatus associated with the apparatus.

Clause 14: The method of any one of Clauses 1-13, wherein exchanging the one or more metrics based on the second communication with the one or more peer apparatuses via at least one of the second type of API or the third type of API at each of the one or more peer apparatuses comprises: sending, directly to a first peer apparatus of the one or more peer apparatuses, via the second type of API or the third type of API at the first peer apparatus, at least one metric of the one or more metrics.

Clause 15: The method of Clause 14, wherein the at least one metric comprises: information associated with the apparatus; or information associated with at least one peer apparatus associated with the first peer apparatus.

Clause 16: The method of any one of Clauses 1-15, wherein: the one or more metrics comprise information associated with the apparatus; and exchanging the one or more metrics based on the third communication with the network entity via the second type of API at the network entity comprises sending, to the network entity, via the second type of API, the one or more metrics.

Clause 17: The method of any one of Clauses 1-16, wherein: the one or more metrics comprise information associated with at least one of the one or more peer apparatuses associated with the apparatus; and exchanging the one or more metrics based on the third communication with the network entity via the second type of API at the network entity comprises: sending, to the network entity, via the second type of API, a request for the one or more metrics; and receiving, from the network entity, the one or more metrics in a return message to the request.

Clause 18: The method of any one of Clauses 1-17, wherein: the one or more metrics comprise information associated with the apparatus; and exchanging the one or more metrics based on the fourth communication with the network entity viathe third type of API exposed at the apparatus comprises: receiving, from the network entity, via the third type of API, a request for the one or more metrics; and sending, to the network entity the one or more metrics in a return message to the request.

Clause 19: The method of any one of Clauses 1-18, wherein: the one or more metrics comprise information associated with at least one of the one or more peer apparatuses associated with the apparatus; and exchanging the one or more metrics based on the fourth communication with the network entity viathe third type of API at exposed the apparatus comprises receiving, from the network entity, via the third type of API, the one or more metrics.

Clause 20: The method of any one of Clauses 1-19, wherein communicating, with the network entity, to register the apparatus with the network entity comprises providing the network entity with an identifier associated with the apparatus comprising at least one of: a FQDN; an IP address; a geolocation; an ID number; or a cell ID.

Clause 21: The method of any one of Clauses 1-20, further comprising: discovering the network entity.

Clause 22: The method of any one of Clauses 1-21, further comprising: receiving a token based on a successful registration of the apparatus with the network entity.

Clause 23: The method of Clause 22, wherein: exchanging the one or more metrics via using the second type of API at the network entity comprises sending, to the network entity, via the second type of API, a message comprising the one or more metrics or a request for the one or more metrics, and the message or the request comprises the token.

Clause 24: The method of any one of Clauses 1-23, wherein: exchanging the one or more metrics based on the third communication with the network entity via the second type of API at the network entity comprises sending, to the network entity, via the second type of API, a message comprising the one or more metrics or a request for the one or more metrics, and the message or the request comprises an identifier associated with the apparatus.

Clause 25: The method of any one of Clauses 1-24, wherein: exchanging the one or more metrics based on the first communication with the one or more peer apparatuses via the third type of API exposed at the apparatus comprises receiving, from the network entity, via the third type of API, a message comprising the one or more metrics or a request for the one or more metrics, and the message or the request comprises at least one of an identifier associated with the apparatus or an identifier associated with the network entity.

Clause 26: The method of any one of Clauses 1-25, wherein exchanging the one or more metrics based on the third communication with the network entity via the second type of API at the network entity or based on the fourth communication with the network entity via the third type of API exposed at the apparatus comprises exchanging the one or more metrics based on at least one of: a configured periodicity; or a trigger event.

Clause 27: The method of any one of Clauses 1-26, wherein the one or more peer apparatuses comprise peer apparatuses associated with the network entity that are neighbors of the apparatus based on a location of each of the one or more peer apparatuses.

Clause 28: The method of any one of Clauses 1-27, wherein the one or more metrics comprise at least one of: a cell resource; an air-interface resource; a cell load; a peer apparatus load; an amplifier load; a measurement on a physical channel; a signal strength value; an interference value; a configuration; a timing advance value; a timestamp; a paging indication; or UE-specific information.

Clause 29: The method of any one of Clauses 1-28, further comprising: receiving, from the network entity, an indication to at least one of: expose at least one of the second type of API or the third type of API at the apparatus; or activate a client at the apparatus to use at least one of the second type of API or the third type of API at each of the one or more peer apparatuses.

Clause 30: The method of any one of Clauses 1-29, further comprising: communicating, with at least one peer apparatus of the one or more peer apparatuses, via the first type of API at the at least one peer apparatus, to register the apparatus with the at least one peer apparatus.

Clause 31: The method of Clause 30, further comprising: receiving, from the network entity, an indication to register the apparatus with the at least one peer apparatus; and communicating, with the at least one peer apparatus, to register the apparatus based on the reception of the indication.

Clause 32: The method of any one of Clauses 1-31, further comprising: receiving, from the network entity, an indication to expose the first type of API at the apparatus to enable the one or more peer apparatuses to register with the apparatus.

Clause 33: The method of any one of Clauses 1-32, further comprising: exchanging an identifier associated with the apparatus with the one or more peer apparatuses.

Clause 34: The method of any one of Clauses 1-33, further comprising: sending, to the network entity, an indication that the one or more metrics were successfully exchanged with at least one peer apparatus of the one or more peer apparatuses.

Clause 35: The method of any one of Clauses 1-34, further comprising: sending, to the network entity, an indication that apparatus failed to successfully exchange the one or more metrics with at least one peer apparatus of the one or more peer apparatuses.

Clause 36: The method of any one of Clauses 1-35, wherein exchanging the one or more metrics based on at least one of the first communication with the one or more peer apparatuses via the second type of API exposed at the apparatus, the first communication with the network entity via the third type of API exposed at the apparatus, the second communication with the one or more peer appratuses via the second type of API at each of the one or more peer apparatuses, or the second communication with the one or more peer appratuses via the third type of API at each of the one or more peer apparatuses, comprises exchanging the one or more metrics based on at least one of: a configured periodicity; or a trigger event.

Clause 37: One or more apparatuses, comprising: one or more memories comprising executable instructions; and one or more processors configured to execute the executable instructions and cause the one or more apparatuses to perform a method in accordance with any one of Clauses 1-36.

Clause 38: One or more apparatuses, comprising: one or more memories; and one or more processors, coupled to the one or more memories, configured to cause the one or more apparatuses to perform a method in accordance with any one of Clauses 1-36.

Clause 39: One or more apparatuses, comprising: one or more memories; and one or more processors, coupled to the one or more memories, configured to perform a method in accordance with any one of Clauses 1-36.

Clause 40: One or more apparatuses, comprising means for performing a method in accordance with any one of Clauses 1-36.

Clause 41: One or more non-transitory computer-readable media comprising executable instructions that, when executed by one or more processors of one or more apparatuses, cause the one or more apparatuses to perform a method in accordance with any one of Clauses 1-36.

Clause 42: One or more computer program products embodied on one or more computer-readable storage media comprising code for performing a method in accordance with any one of Clauses 1-36.

Clause 43: A user equipment (UE), comprising: a processing system that includes processor circuitry and memory circuitry that stores code and is coupled with the processor circuitry, the processing system configured to cause the UE to perform a method in accordance with any one of Clauses 1-36.

Clause 44: A network entity, comprising: a processing system that includes processor circuitry and memory circuitry that stores code and is coupled with the processor circuitry, the processing system configured to cause the network entity to perform a method in accordance with any one of Clauses 1-36.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors, coupled to the one or more memories, configured to cause the apparatus to:
communicate, with a network entity, via a first type of application programming interface (API) at the network entity, to register the apparatus with the network entity; and
exchange one or more metrics with one or more peer apparatuses associated with the network entity based on at least one of:
a first communication with the one or more peer apparatuses via at least one of a second type of API or a third type of API exposed at the apparatus;
a second communication with the one or more peer apparatuses via at least one of the second type of API or the third type of API at each of the one or more peer apparatuses;
a third communication with the network entity via the second type of API at the network entity; or
a fourth communication with the network entity via the third type of API exposed at the apparatus.

2. The apparatus of claim 1, wherein the one or more processors are configured to cause the apparatus to:
send, to the network entity, via the second type of API at the network entity or a fourth type of API, a request to communicate the one or more metrics directly with the one or more peer apparatuses; and
receive a message comprising location information for each of the one or more peer apparatuses.

3. The apparatus of claim 2, wherein the location information for each of the one or more peer apparatuses comprises a fully qualified domain name (FQDN) or an internet protocol (IP) address.

4. The apparatus of claim 1, wherein the one or more processors are configured to cause the apparatus to send, to the network entity, via the second type of API at the network entity or a fourth type of API, a message comprising location information for each of the one or more peer apparatuses.

5. The apparatus of claim 2, wherein the one or more processors are configured to cause the apparatus to receive, from the network entity, via the third type of API at the apparatus or a fourth type of API, a message comprising location information for each of the one or more peer apparatuses.

6. The apparatus of claim 1, wherein to exchange the one or more metrics based on the first communication with the one or more peer apparatuses via at least one of the second type of API or the third type of API exposed at the apparatus, the one or more processors are configured to cause the apparatus to:
receive, directly from a first peer apparatus of the one or more peer apparatuses, via the second type of API or the third type of API, a request for at least one metric of the one or more metrics; and
send, directly to the first peer apparatus, the at least one metric in a return message to the request.

7. The apparatus of claim 6, wherein the at least one metric comprises:
information associated with the apparatus; or
information associated with at least one peer apparatus associated with the first peer apparatus.

8. The apparatus of claim 1, wherein to exchange the one or more metrics based on the first communication with the one or more peer apparatuses via at least one of the second type of API or the third type of API exposed at the apparatus, the one or more processors are configured to cause the apparatus to:
receive, directly from a first peer apparatus of the one or more peer apparatuses, via the second type of API or the third type of API, at least one metric of the one or more metrics.

9. The apparatus of claim 1, wherein to exchange the one or more metrics based on the second communication with the one or more peer apparatuses via at least one of the second type of API or the third type of API at each of the one or more peer apparatuses, the one or more processors are configured to cause the apparatus to:
send, directly to a first peer apparatus of the one or more peer apparatuses, via the second type of API or the third type of API at the first peer apparatus, a request for at least one metric of the one or more metrics; and
receive, directly from the first peer apparatus, the at least one metric in a return message to the request.

10. The apparatus of claim 1, wherein to exchange the one or more metrics based on the second communication with the one or more peer apparatuses via at least one of the second type of API or the third type of API at each of the one or more peer apparatuses, the one or more processors are configured to cause the apparatus to:
send, directly to a first peer apparatus of the one or more peer apparatuses, via the second type of API or the third type of API at the first peer apparatus, at least one metric of the one or more metrics.

11. The apparatus of claim 1, wherein:
the one or more metrics comprise information associated with the apparatus; and
to exchange the one or more metrics based on the third communication with the network entity via the second type of API at the network entity, the one or more processors are configured to cause the apparatus to send, to the network entity, via the second type of API, the one or more metrics.

12. The apparatus of claim 1, wherein:
the one or more metrics comprise information associated with at least one of the one or more peer apparatuses associated with the apparatus; and
to exchange the one or more metrics based on the third communication with the network entity via the second type of API at the network entity, the one or more processors are configured to cause the apparatus to:
send, to the network entity, via the second type of API, a request for the one or more metrics; and
receive, from the network entity, the one or more metrics in a return message to the request.

13. The apparatus of claim 1, wherein:
the one or more metrics comprise information associated with the apparatus; and
to exchange the one or more metrics based on the fourth communication with the network entity via the third type of API exposed at the apparatus, the one or more processors are configured to cause the apparatus to:
receive, from the network entity, via the third type of API, a request for the one or more metrics; and
send, to the network entity the one or more metrics in a return message to the request.

14. The apparatus of claim 1, wherein:
the one or more metrics comprise information associated with at least one of the one or more peer apparatuses associated with the apparatus; and
to exchange the one or more metrics based on the fourth communication with the network entity via the third type of API exposed at the apparatus, the one or more processors are configured to cause the apparatus to receive, from the network entity, via the third type of API, the one or more metrics.

15. The apparatus of claim 1, wherein to communicate, with the network entity, to register the apparatus with the network entity, the one or more processors are configured to cause the apparatus to provide the network entity with an identifier associated with the apparatus comprising at least one of:
a fully qualified domain name (FQDN);
an internet protocol (IP) address;
a geolocation;
an identification (ID) number; or
a cell ID.

16. The apparatus of claim 1, wherein:
the one or more processors are configured to cause the apparatus to receive a token based on a successful registration of the apparatus with the network entity,
to exchange the one or more metrics based on the third communication with the network entity via the second type of API at the network entity, the one or more processors are configured to cause the apparatus to send, to the network entity, via the second type of API, a message comprising the one or more metrics or a request for the one or more metrics, and
the message or the request comprises the token.

17. The apparatus of claim 1, wherein the one or more peer apparatuses comprise peer apparatuses associated with the network entity that are neighbors of the apparatus based on a location of each of the one or more peer apparatuses.

18. The apparatus of claim 1, wherein the one or more metrics comprise at least one of:
a cell resource;
an air-interface resource;
a cell load;
a peer apparatus load;
an amplifier load;
a measurement on a physical channel;
a signal strength value;
an interference value;
a configuration;
a timing advance value;
a timestamp;
a paging indication; or
user equipment (UE)-specific information.

19. A method for wireless communications by an apparatus comprising:
communicating, with a network entity, via a first type of application programming interface (API) at the network entity, to register the apparatus with the network entity; and
exchanging one or more metrics with one or more peer apparatuses associated with the network entity based on at least one of:
a first communication with the one or more peer apparatuses via at least one of a second type of API or a third type of API exposed at the apparatus;
a second communication with the one or more peer apparatuses via at least one of the second type of API or the third type of API at each of the one or more peer apparatuses;
a third communication with the network entity via the second type of API at the network entity; or
a fourth communication with the network entity via the third type of API exposed at the apparatus.

20. One or more non-transitory computer-readable media comprising executable instructions that, when executed by one or more processors of an apparatus, cause the apparatus to perform operations comprising:
communicating, with a network entity, via a first type of application programming interface (API) at the network entity, to register the apparatus with the network entity; and
exchanging one or more metrics with one or more peer apparatuses associated with the network entity based on at least one of:
a first communication with the one or more peer apparatuses via at least one of a second type of API or a third type of API exposed at the apparatus;
a second communication with the one or more peer apparatuses via at least one of the second type of API or the third type of API at each of the one or more peer apparatuses;
a third communication with the network entity via the second type of API at the network entity; or
a fourth communication with the network entity via the third type of API exposed at the apparatus.
